(19) United States
(12) Patent Application Publication
(10) Pub. No.: US 2020/0401571 A1
(43) Pub. Date: Dec. 24, 2020

(54) Human Experiences Ontology Data Model and its Design Environment

(71) Applicant: Svetlana Poliakova, New York, NY (US)

(72) Inventor: Svetlana Poliakova, Moscow (RU)

(73) Assignee: EVOLUTION PATHFINDER LLC, New York, NY (US)

(21) Appl. No.: 16/449,754

(22) Filed: Jun. 24, 2019

(51) Int. Cl. G06F 16/22; G06F 16/28; G06F 16/25; G06N 20/00; G06F 17/27

(52) U.S. Cl. CPC G06F 16/2291; G06F 16/285; G06F 17/2785; G06N 20/00; G06F 16/258

(57) ABSTRACT

Structuring data, content, video, texts, and other narratives for researching complex adaptive systems requires new approaches and flexible data modelling tools. Those tools have to allow conceptualizing contexts and other semantic structures of the information. The invention addresses the problem with a method for designing and transmitting semantic digital codes and semantic digital structures of human experiences. The method can be applied to the processes of seeking patterns in big volume of information within various professional areas like Social Studies, Genomics, Mathematical Sociology, Digital Humanities, and other knowledge domains. The frameworks and semantic digital structures of human experiences provided with the Human Experiences Ontology Data Model can be integrated into metadata, systems of tags and training datasets for Machine Learning. The semantic digital structures of human experiences which are created in one professional area or language can be transmitted to other knowledge domains and languages.

### BACKGROUND

### Field of the Invention

The present invention is a computer-implemented methodology in the field of semantic structuring of information and methods of transmitting data.

### SUMMARY

The present invention is directed to organize information in the way that allows designing semantic structures and transmitting them between institutions, persons, different professional areas, and knowledge domains.

In various scientific and business areas, there is a demand for data modelling tools with which mining knowledge about patterns in complex adaptive systems would be provided on the higher level of flexibility. Such tools have to allow conceptualizing information about human life in the form that reflects contexts and intrinsic traits of life, like uncertainty, emergence, and eventuality. Existing taxonomies and systems of tags often are not appropriate in modelling living systems.

Therefore, it would be advantageous to provide a system and method for designing semantic digital structures of human experiences that address the demand and can be applied to different methodologies. The following aspects of the invention represent the solution for that problem:
The basic unit of the invention is the semantic digital code of human experience. When it comes to classifying human experiences, perceiving experience as event and creating the classifications of events is the most common method. This method lacks of contexts. During one event “Birthday party”, birthday boy, his parents, and the owner of the event-company will have different experiences.

Human Experiences Ontology Data Model considers human experience the complex structure, in which the subjective part, context, exists as well. That means that one event can evoke different experiences in different situations. And it can be described in the metalanguage of the method.
Basically, artificial intelligence models are being trained with natural languages. Natural language analysis is a very powerful instrument. But extracting senses, contexts, and categories of human experiences from narratives by means of the existing technologies is a problem.

In order to present human experiences to algorithms, subjective senses and contexts rather than word's structure, we must convert subjective senses and contexts to digital codes. That is the problem which the invention resolves.
Human Experiences Ontology Data Model allows creating semantic digital structures of human experiences for one narrative in different ways in accordance to the purposes of the specialist who deals with it and to their personal judgment. The specialists can test various semantic digital structures of one narrative within training materials for Machine Learning processes in order to choose the version that provides the best result for their professional domain.
Human Experiences Ontology Data Model allows mapping fields from external classifications to semantic digital codes of human experiences within the data model. That means that, for instance, climate types from climate classifications, names of social institutions or historical figures, diseases from common classifications, and many other aspects of human life from external classifications can be integrated into semantic digital structures as a part of human experiences.
There are large semantic classifications and taxonomies that are useful in cataloguing and storing big volume of artefacts and data in libraries, archives, and business technologies. At the same time, those ontologies might be inappropriate for researching living systems. Sometimes, firm classificatory structures, into which human knowledge has been shaped, are problematic for creating new knowledge. For example, conventional classifications of social identities do not correspond to the complexity and stochastic observations of research in Genomics. Scientists who investigate the influence of social factors to genome accentuate the problem of integrating social classifications and the knowledge about social processes into genetic research. The ways in which scientists conceptualize the relationship between social identities and genetic variation create the demand for methods of structuring social information in form of assemblies of human experiences.

A metasystem (system of signs) based on the method of the invention provides modelling tools for designing research frameworks with assemblies of human experiences.
Rigid taxonomies that are used within one knowledge domain lack of complexity and flexibility for integrating to another domain—they can be transmitted only as the whole structures.

The invention is neither rigid structure nor the compilation of classifications. It is the concept for designing flexible structures that can reflect subjectivity of human experience. So, the classifiers within the method are more like paints for artists. That is a new form of perception of ontologies and classifiers.
Common tags systems are useful within one information environment, blogs o video platforms. But they are inappropriate for collecting knowledge about humans as living systems.

With Human Experiences Ontology Data Model, digital structures and codes of human experiences can be applied as new type of tags and markups. Those structures are complex and flexible and, at the same time, can be easy integrated into metadata or any computer program.

For example, if the researcher is interested in fathering experiences he or she can search for narratives in which historic figures, fathers, express their love. With existing technologies, they will be able to find the narratives that named with such words explicitly. However, expressing love is experience that can be reflected in plenty words. It depends on context.

In some embodiments of the invention that problem can be resolved. If a library uses the codes of human experiences (system of signs) of the invention for attributing a complex of historical documents, then someone can use searching algorithms in other way. For example, a person will provide a request for searching specific texts in which the following two notions are mapped as a semantic part of the text: “Expressing love—Daughter”. In that example, the request will have such a format with identifiers of the Human Experiences Ontology Data Model (see 1102, 1103 in Drawings):

800001008-10005-10000000000408

As the result, all the narratives that are marked with the codes of human experiences and have that the same code of human experience in their semantic structure (in this example, the code is 800001008-10005-10000000000408) will be easy determined by the searching algorithms. The advantage here is that the result of searching is the set of narratives which have the context in common rather than the names or words.

### BRIEF DESCRIPTION OF THE DRAWINGS

FIG. 1 depicts the general structure of Human Experiences Ontology Data Model.

FIG. 2A illustrates the structure of the classification of human actions, states of being, feelings, and processes “Library of Doings and Beings”.

FIG. 2B illustrates an example of fields from the database of the classification “Library of Doings and Beings”.

FIG. 3A illustrates the structure of the classification of contexts “Library of Contexts”.

FIG. 3B illustrates an example of fields from the database of the classification “Library of Contexts”.

FIG. 3C depicts an example of special groups of contexts from “Library of Contexts”—external classifications.

FIG. 4 depicts the format of semantic digital code Experience_Code.

FIG. 5 is a block diagram that illustrates the process of designing Experience_Code.

FIG. 6 illustrates examples of semantic structures that can be represented as Experience_Graph FIG. 7 illustrates the example of semantic structure of Experience_Story.

FIG. 8 illustrates one example of embodiment, transmitting codes of human experiences through Unit of Sociocultural Information (USCI).

FIG. 9 Example of Embodiment. Integrating structured information about human experiences into metadata and other data about narratives.

FIG. 10 Example of Embodiment. Extracting structured information about human experiences from metadata and other data about a narrative.

FIG. 11 Example of Embodiment. Semantic digital structures for attributing a narrative.

FIG. 12A Example of Embodiment. Artificial Intelligence (AI) and Machine Learning.

FIG. 12B Example of Embodiment. Evolutionary Processes and Complex Adaptive Systems.

FIG. 12C Example of Embodiment. Libraries and Archives. Digital Humanities.

FIG. 13A Example of Embodiment. Codes of Human Experiences within Knowledge Domain “Genomics, Epigenetics, and Bioinformatics”.

FIG. 13B depicts one embodiment of the invention, creating a framework for research.

FIG. 14 Example of Embodiment. Social Environment and Social Listening.

FIG. 15 Example of Embodiment. Searching Algorithms.

FIG. 16 Example of Embodiment. Market Intelligence and Customer Journey Map.

FIG. 17 Example of Embodiment. Analytical Platforms.

FIG. 18 depicts Design Environment of the Human Experiences Ontology Data Model.

### DETAILED DESCRIPTION

The basic item of the invention is human experience. How to describe human experience? The invention is based on the concept that any human experience is subjective. It means that there is no such a thing like typical human experience—something like an action or a state of being that is the same experience for everybody. Certainly, there is an action, event, behavioral pattern, feeling, or state of being. However, they are not the same whoever considers them. For example, walking or eating cannot be described correctly as human experiences until we indicate for whom these experiences are. People who are walking or eating are experiencing the action according to the situations and senses that are organic for them, according to their own mentality, according to their personal judgments etc. Another person who is observing the actions might consider walking or eating with the own system of values, priorities, and other personal categories. Personal situation and categories like mood, health, social status, place of action, or place of observing can evoke different experiences as for the person in action, as for the observer. Furthermore, researcher who investigates eating and walking activities in computer games could consider the experience of the “person in action” within the methodological system of the research and say nothing about the experience of the observer or about people in the real world beyond the world of computer games.

Taking that into account, the methodology of the invention is based on the following conceptual statements:
a person can attribute any narrative (including data, report or semantic structure) with the means of the invention and get a set of semantic digital codes (identifiers) or semantic digital structures that reflect the structure of the human experiences in the narrative.
for designing semantic digital codes of human experiences for a narrative by means of the invention, two classes of information are to be extracted from the source:
   Class 1. That is the information about what occurs or exists. It includes actions, states of being, feelings, processes that are presented in the narrative.
   Class 2. That is the information about contexts. It describes in which contexts the information of the Class 1 is presented in the narrative.

For attributing narratives by semantic digital codes of human experiences, the method and means of the invention are to be used. The Human Experiences Ontology Data Model consists of the set of identifiers for information of Class1—the classification “Library of Doings and Beings”, and the set of identifiers for information of Class 2—the classification “Library of Contexts”. Mapping identifiers of Class1 to identifiers of Class 2 is the way for creating semantic digital codes of human experiences.

Other concepts that are the key parts of the detailed description of the invention:

Narrative is a report of human experience in all forms which can include yet are not limited to: texts, data, oral storytelling, letters, documents, non-fiction, biographies, poetry, myths, legends, songs, plays, paintings, videos, films, games, messages.

Domain is a professional area, including its network, knowledge, and software.

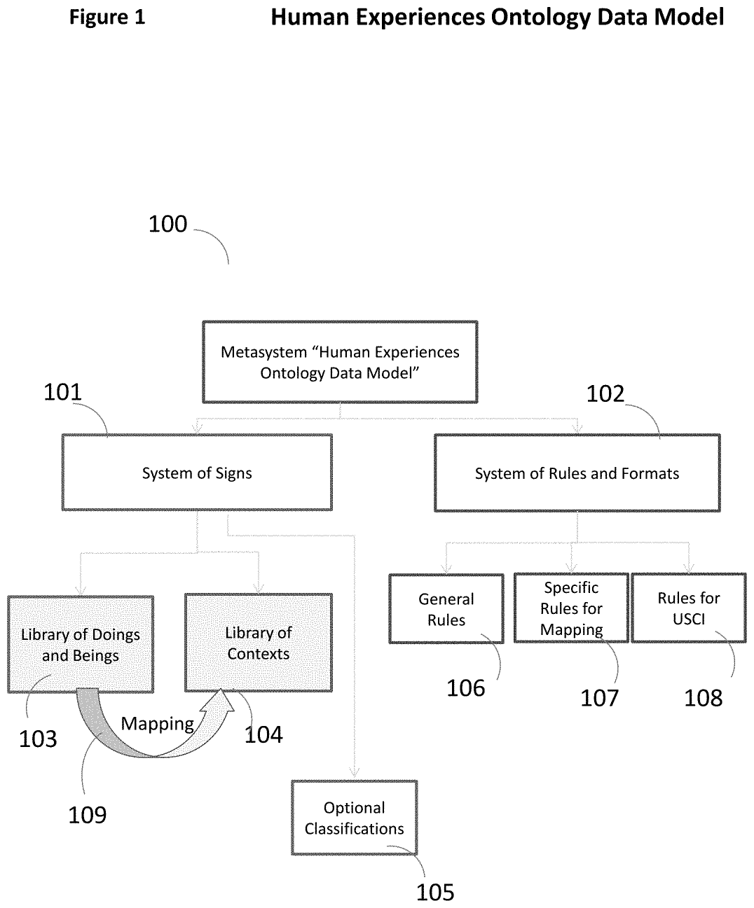

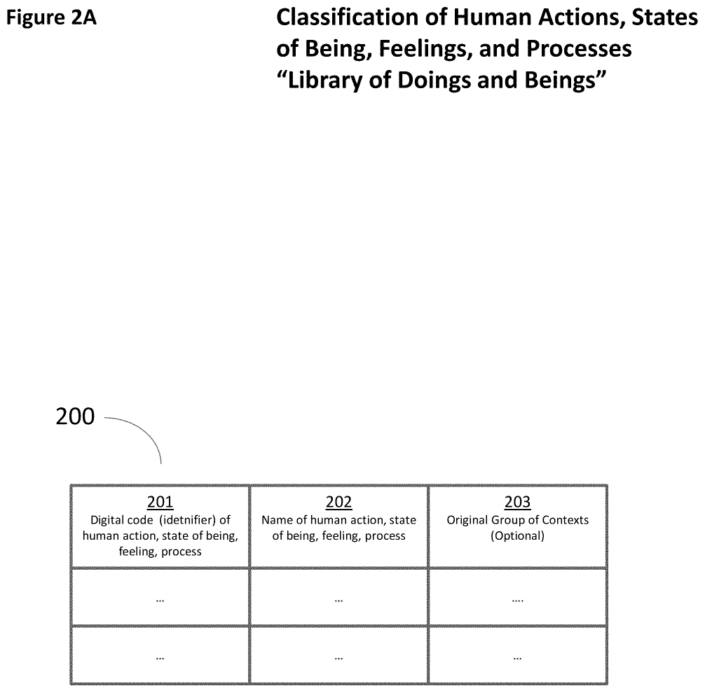

FIG. 1 depicts the general structure of a metasystem Human Experiences Ontology Data Model.

The Human Experiences Ontology Data Model 100 is a method and a system for designing semantic digital codes and semantic digital structures for attributing information in various formats and in various information systems. The semantic digital codes and semantic digital structures can be stored and used in numerous databases and networks. In this embodiment, the semantic digital codes are created in accordance to System of Signs 101 and System of Rules and Formats 102. The System of Signs 101 includes two mandatory registries that reflect individual and social reality:

1) Classification “Library of Doings and Beings” 103—a registry and a set of identifiers of human actions, states of being, feelings, and processes;
2) Classification “Library of Contexts” 104—a registry and a set of identifiers of contexts.

The classifications “Library of Doings and Beings” and “Library of Contexts” have being created, stored, and changed on the computer system (hardware infrastructure) which might be separated from those program applications and devices which use the System of Signs 101, attribute and analyze narratives with Human Experiences Ontology Data Model. The classifications “Library of Doings and Beings” and “Library of Contexts” (103 and 104) and the System of Rules and Formats 102 are stored in centralized databases and data structures. Therefore, in one embodiment, the user who creates semantic attributes from 101 for a narrative on their personal computer, or retrieves it from metadata, uses a computer program which allows using the System of Signs 101. This computer program refers to the semantic descriptions and data structures that exist beyond the personal computer of the user or the server where the computer program operates, it refers to the centralized classifications “Library of Doings and Beings” and “Library of Contexts”, System of Codes, and System of Rules. At the same time, an actual copy of System of Codes can be stored and supported on the personal computer or server of the user in specific implementations.

In other embodiments, there can be different processes organized for dealing with the method 100, classifications (103 and 104), or supporting methodological systems (102). For supporting the actual version of the System of Signs 101 different methods can be implemented: copying data from centralized databases of Human Experiences Ontology Data Model, periodical uploading data sets, creating data marts and others.

In order to attribute a narrative, data or semantic structure by using Human Experiences Ontology Data Model, the following semantic digital codes and semantic digital structures are supposed to be created and used:

Experience_Code (in the plural—Experience_Codes)
Experience_Graph (in the plural—Experience_Graphs)
Experience_Story (in the plural—Experience_Stories)

Detailed descriptions of those data structures are in the following figures. Those semantic digital codes and digital structures must be created in accordance to instructions and methodological supporting systems (102, 106, 107).

Experience_Code, Experience_Graph, Experience_Story, Experience_Parameter may be integrated into metadata, custom data model, various databases etc. Some general rules and requirements for integrating them into other systems are established in rules for creating, storing, and transmitting USCI (108).

Mapping 109 is the process of creating Experience_Code by mapping one digital code (identifier) from “Library of Doings and Beings” to one digital code (identifier) of context from “Library of Contexts”, including the identification number of the group of the context.

Classifications “Library of Doings and Beings” and “Library of Contexts” are the obligatory part of the process of creating Experience_Code. Also, System of Codes has optional classifications 105. Codes from optional classifications might be used in Experience_Code within specific areas, supporting processes or specific computing programs.

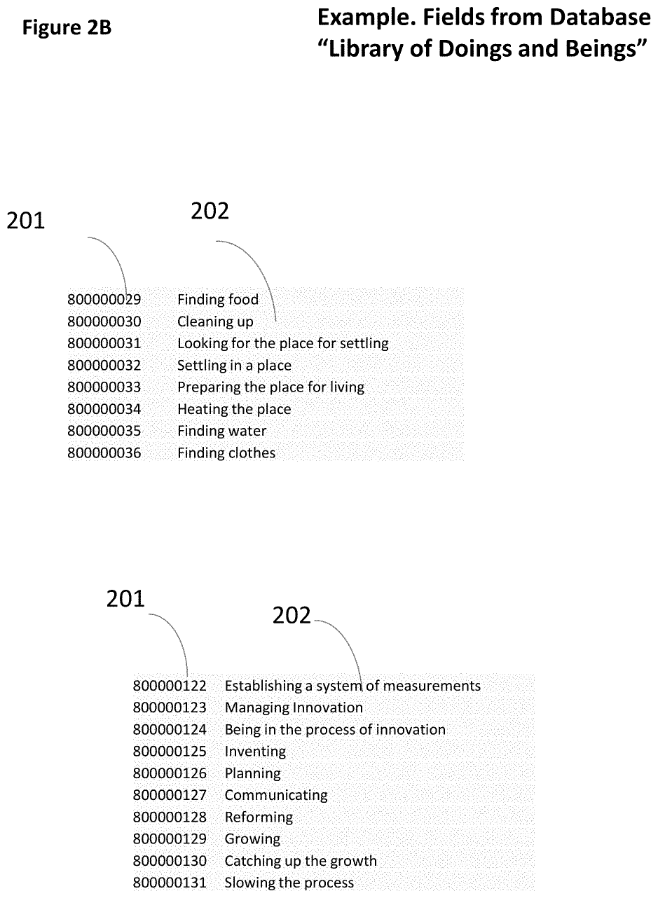

FIG. 2A illustrates the structure of the classification “Library of Doings and Beings” (see 103 in FIG. 1).

The classification “Library of Doings and Beings” 200 is the registry of human actions, states of being, feelings, and processes that reflect human and social life. Each human action, state of being, feeling, and process has its own digital code (identifier) 201. One entry of “Library of Doings and Beings” includes a name 202 of a human action, state of being, feeling, and process, its digital code (identifier) 201, and (optional) the identification number of original group of contexts 203 from “Library of Contexts”. Original groups of contexts are being used for grouping entries of “Library of Doings and Beings” and other technological procedures. That means that, in the process of creating codes of human experiences, semantic attributes for narratives, and other implementations of Human Experiences Ontology Data Model, other identification numbers of groups of contexts can be associated to the pair 201 and 202—digital code (identifier) and name from “Library of Doings and Beings”.

First character of the code 201 is the indicator of the classification “Library of Doings and Beings”, common classification or special classification of the domain.

FIG. 2B illustrates a part of a database that includes several fields of the classification “Library of Doings and Beings”.

Digital code (identifier) 201 is the primary key in the database.

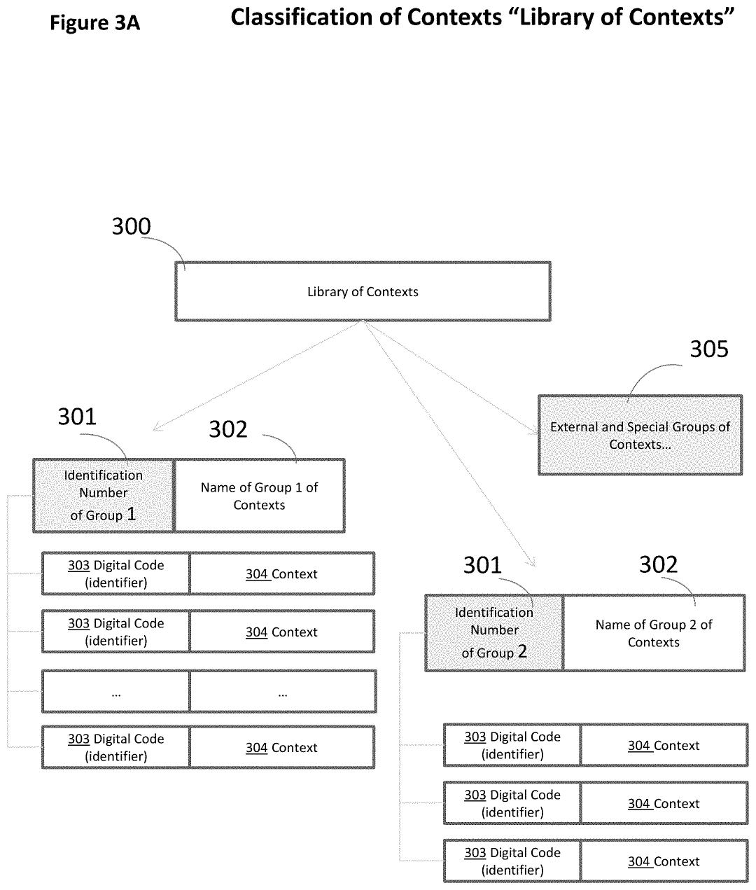

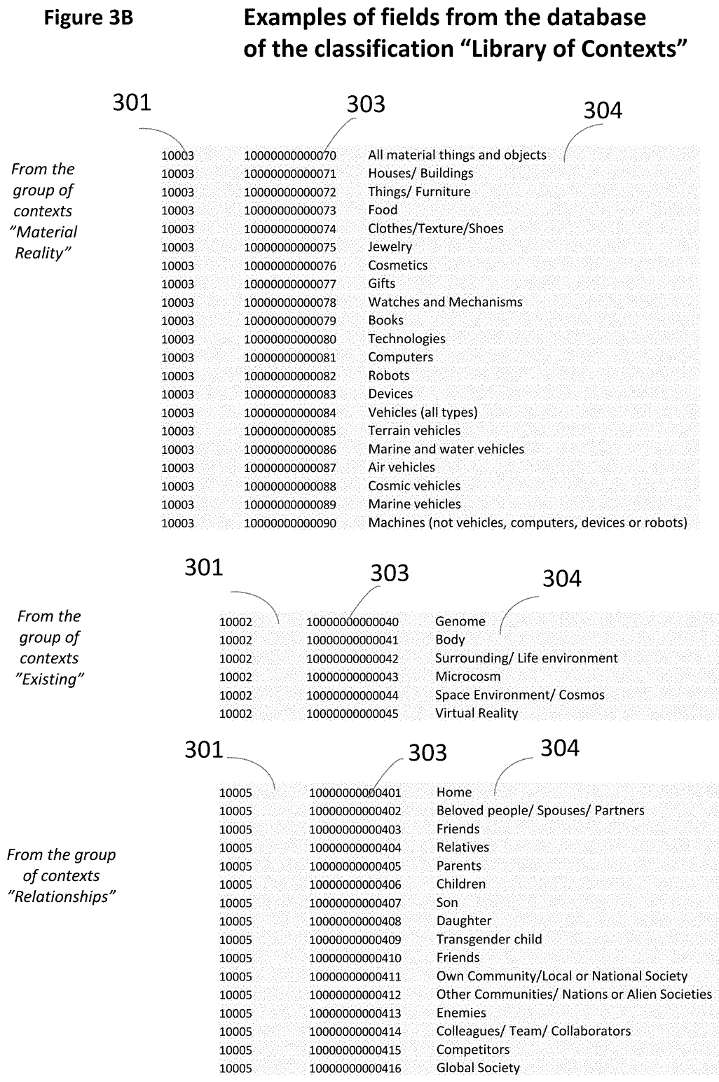

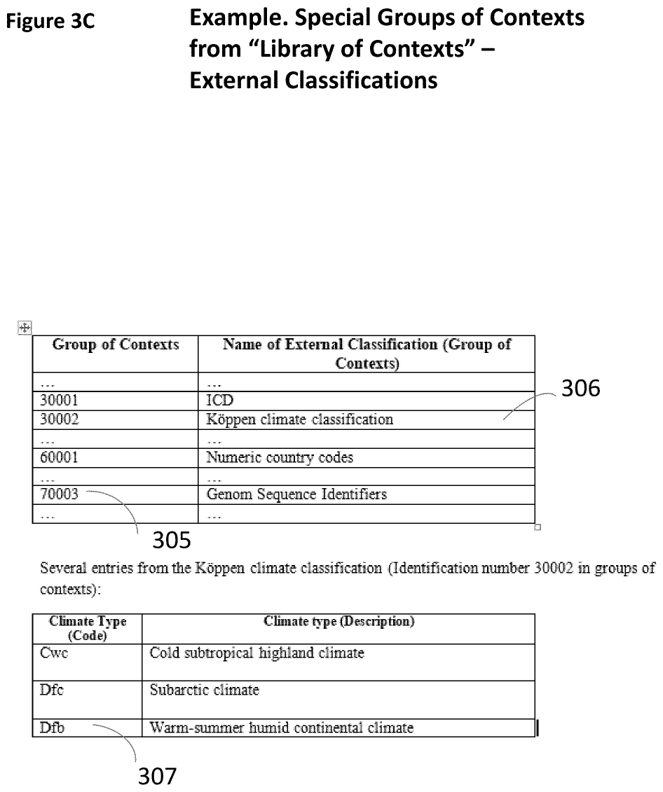

FIG. 3A illustrates the structure of the classification “Library of Contexts”.

The classification “Library of Contexts” determines contexts 304 in which a human action, state of being, feeling, and process is presented in the narrative, data, or semantic structure o information. All contexts are divided into the groups 300 according to the topic or structure. Every group of contexts 300 has its unique 5-character digital identification number 301 and the name of the group 302.

Every context within the classification “Library of Contexts” comprises
its unique 14-character digital code (identifier) 303
and a name of context 304.

FIG. 3B illustrates a part of a database that includes several fields of the classification “Library of Contexts”. There are 3 sets of contexts in the picture as an example.

Name 302 of the first group of contexts is “Material Reality”, its 5-character identification number—10003.

Name of the third group of contexts is “Existing”, its 5-character identification number—10002

Name of the third group of contexts is “Relationships”, its 5-character identification number—10005.

Every context has its unique 14-character digital code (identifier) 303, which is the primary key for context in the database.

The classification “Library of Contexts” is proposed to be developed. That means that new contexts and fields of the database will be added.

FIG. 3C is an example of special groups of contexts—external classifications. In embodiments of the invention, every external classification has its own 5-character digital identification number 305 as a group of contexts. The name of the classification 306 corresponds to the identification number 305 in the classification “Library of Contexts”.

Codes of entries of external classifications are being used as digital codes (identifiers) of contexts. For example, the type of climate Dfb 307 can be represented as the 14-character digital code (identifier) of context in the following way:

### 00000000000Dfb

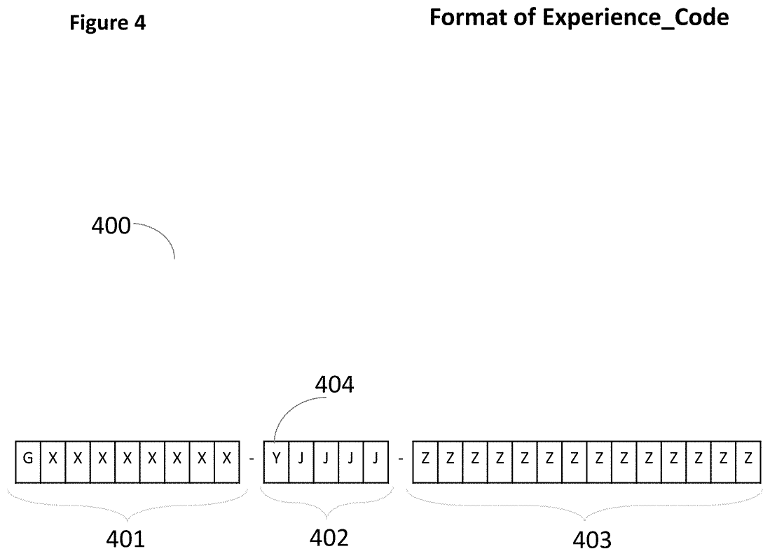

FIG. 4 depicts the format and the structure of semantic digital code Experience_Code.

Experience_Code 400 is the 28-character semantic digital code made up of several identifiers. The order of the characters and their certain significance are determined by the following rules:

First 9-character part 401 is the digital code (identifier) of a human action, state of being, feeling, or process from the classification “Library of Doings and Beings” (see 201 in FIG. 2).
Second 5-character part 402 indicates the group of contexts to which the context from the third part 403 of Experience_Code belongs. First character 404 of the second part indicates which kind of classifications is being used for the context 403.
Third 14-character part of the Experience_Code 403 is the digital code (identifier) of the context from the classification “Library of Contexts”.

“G”—is an integer number from 0 to 9.

“X”—an integer number from 0 to 9.

“Y”—an integer number from 1 to 9 that indicates if it is a standard classification of contexts from “Library of Contexts” or an external classification. Y can be determined in accordance to the following:

| Value of “Y” 404 | Type of Classifications or Groups of Contexts |
|---|---|
| 1 | Group of contexts from the common part of the |
| | classification “Library of Contexts” |
| 2 | Reserved |
| 3 | External Classifications (different types) |
| 4 | Reserved |
| 5 | External Classifications. Time. Historical Periods |
| 6 | External Classifications. Place. Geographical |
| | Parameters. Coordinates |
| 7 | External Classifications. Genomic Classifications |
| | like GI numbers (electronic databases of sequence |
| | information and databases describing genotype- |
| | phenotype associations) |
| 8 | Reserved |
| 9 | Custom Classifications |
| 0 | Technical Groups of Contexts |

“J”—an integer number from 0 to 9.
Z—an integer number from 0 to 9, character or special symbol

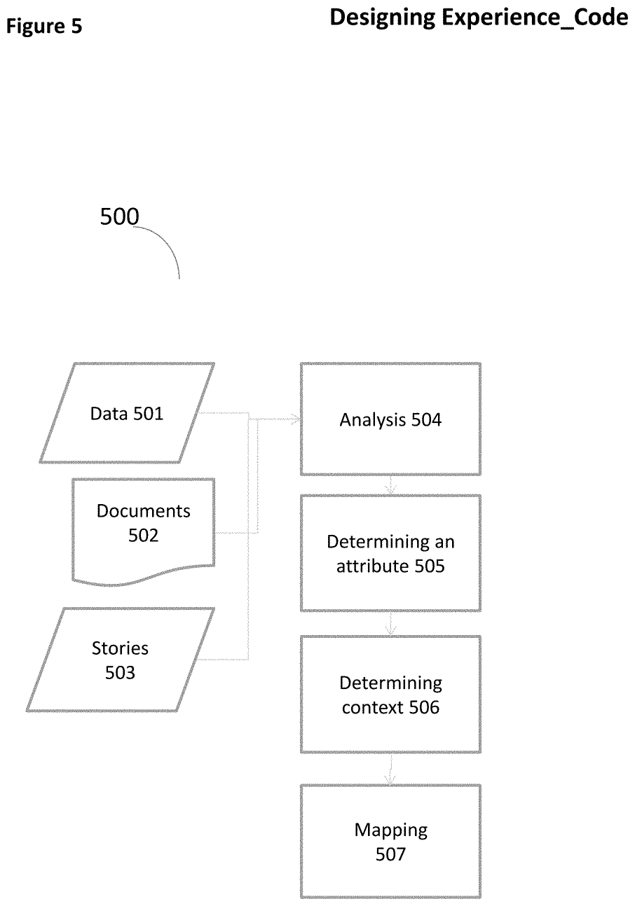

FIG. 5 depicts a flow for creating a semantic digital code Experience_Code.

In order to get semantic digital code of human experience which are presented in a narrative, the method of designing Experience_Code 500 can be used. In one embodiment of the invention, the narratives-sources can exist in different formats: data 501, documents 502, stories 503 or other types of narratives that are named as narratives within the description of the invention.

Step 1 of designing Experience_Code is the analysis 504 of the narrative. The analysis includes determining the information of Class1 with questions “What occurs?” and “What is going on?”.

After that, information of Class2 should be extracted, in which context the information of Class 1 is presented.

Step 2 505 is looking for an attribute from the classification “Library of Doings and Beings” (See 103 in FIG. 1 and the structure in FIG. 2) that expresses the human action, state of being, feeling, or process which was detected during the Step 1. The digital code (identifier) of that from the classification “Library of Doings and Beings” is the first part of the Experience_Code (see 401 in FIG. 4)

Step 3 is looking for the context in the classification “Library of Contexts” 506 that expresses the information of Class2 about contexts, which was provided during the analysis 504. The digital code of the context from the classification “Library of Contexts” is the third part of the Experience_Code (see 403 in FIG. 4). The group of contexts which the context belongs to is the second part of the code (see 402 in FIG. 4)

For example, we can use fields from FIG. 2B and FIG. 3B for illustrating the process 500. If during Step 1 we found out that the narrative is about heating houses then Step 2 and Step 3 look like the following:

### Step 2:

| Digital code (identifier) of an | Name of human action, |
|---|---|
| attribute from “Library of | state of being, |
| Doings and Beings” | feeling, or process |
| 800000034 | Heating the place |

### Step 3:

| Identification number | Digital code | |
|---|---|---|
| of a group of contexts | (identifier) | |
| “Library of Contexts” | of context | Name of context |
| 10003 | 10000000000071 | Houses/Buildings |

Finally, the Experience_Code in that example of embodiment is:

800000034-10003-1000000000007

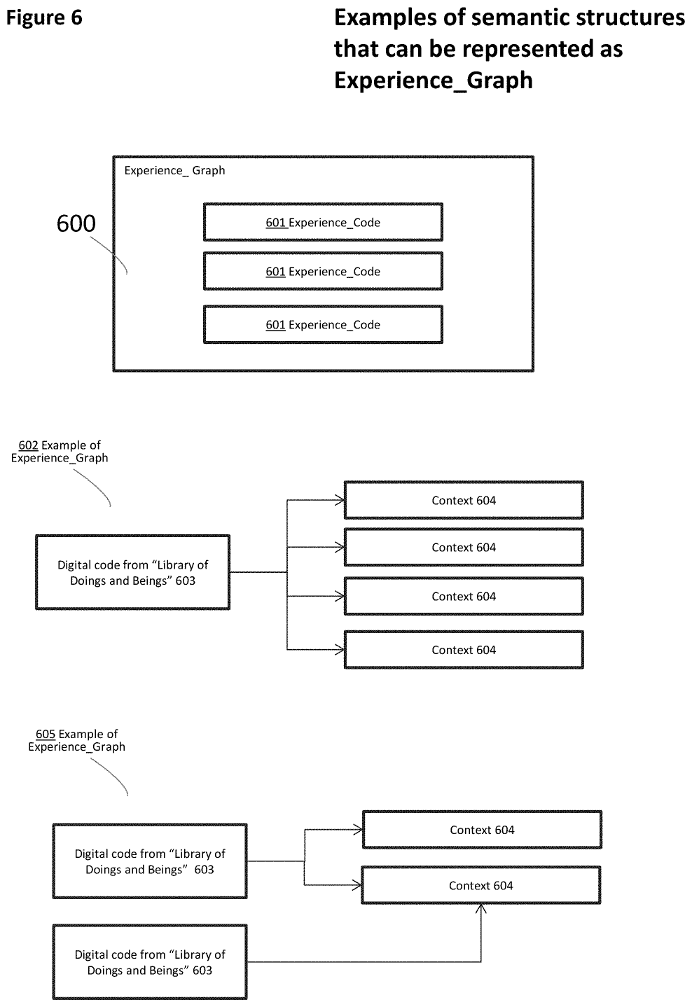

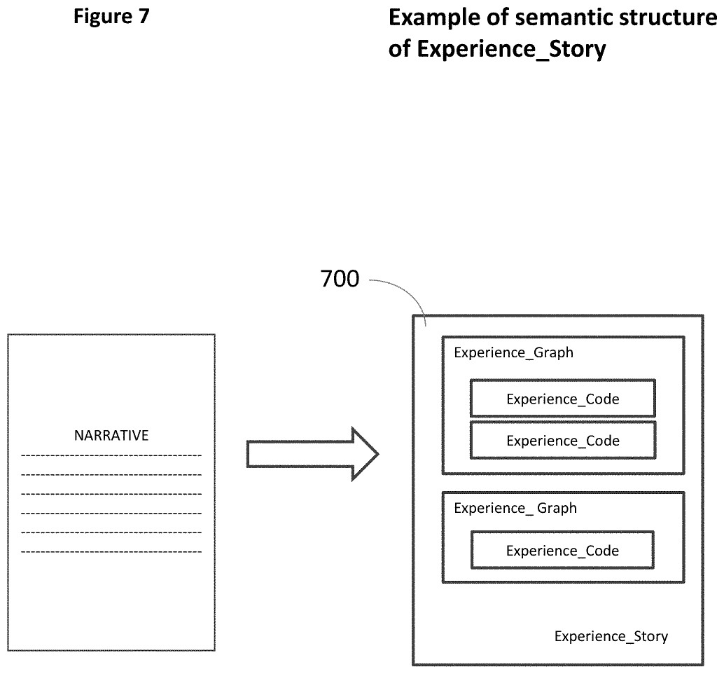

FIG. 6 depicts the examples of semantic structure of Experience_Graph.

Within the method, several semantic digital codes that express human experiences (Experience_Codes) 601 can be organized together into semantic digital structure Experience_Graph 600 for attributing a narrative. In some embodiments, the narrative can be a paragraph, or one semantic structure, or a structural part of the narrative. For example, there can be chapters in the book, or episodes of a movie, sentences in a paragraph. For every chapter, episode, or sentence a separate Experience_Graph 600 can be created.

That means that a person who uses Human Experience Ontology Model chooses the semantic structure and a concrete part of the narrative to be attributed by Experience_Code and Experience_Graph. There are no boundaries for the volume of the narrative. It is similar to the method we use natural language—we can say what is a whole movie about, we can say what is the episode of the movie about, and we can say what is a scene on specific time of the movie is about. Our choice of movie/episode/scene depends on the situation and our purposes in the conversation, while for all the situations we can use the same set of words. The similar “no boundaries” approach is proposed for choosing a part of the narrative for attributing them by codes Experience_Code and Experience_Graph.

In FIG. 6, a few semantic structures are presented, 602 and 605, as examples of ways how identifiers and codes from System of Signs (see FIG. 1) can be semantically connected within one Experience_Graph. In example 602 one human action or state of being from “Library of Doings and Beings” 603 is connected to several different contexts 604 from “Library of Contexts”. In example 605, there is a part of the structure where several actions or feelings from “Library of Doings and Beings” 603 are connected to one context 604 from “Library of Contexts”. There can be various ways of structuring Experience_Graph, and the ways are not limited by examples.

FIG. 7 depicts one example of semantic structure of Experience_Story.

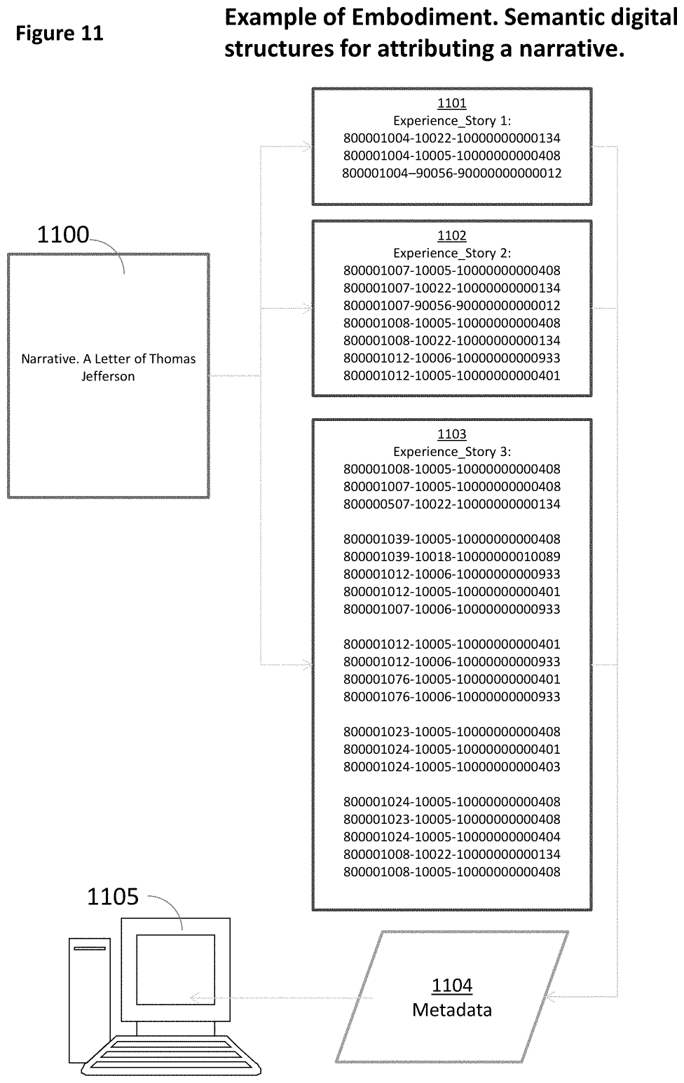

Experience_Story 700 is a semantic digital structure for one narrative. Experience_Story comprises sets of Experience_Codes and Experience_Graphs. There can be several different Experience_Stories for one narrative (see FIG. 11). Each Experience_Story reflects the vision and intention of the person (or artificial intelligence machine) that creates it.

For technical purposes and for the estimation of the semantic digital structures, Experience_Parameter can be used. Experience_Parameter is a quantitative index that reflects the relation between the size of narrative and amount of semantic digital codes Experience_Codes which are created for attributing it. The value of Experience_Parameter is the integral part of the value of the fraction where the numerator is the size of the narrative, and the denominator is the amount of Experience_Codes. As the size of narrative can be measured in amount of words or in time measures (e.g., the duration of films or interviews), there are 4 types of Experience_Parameters that have different units of measurement:
Experience_Parameter 1. The integral part of the value of the fraction “Amount of words to amount of Experience_Codes”. The unit of measurement of Experience_Parameter 1−wdc:
Expereince_Parameter 1=[(Amount of words in the narrative)/(Amount of digital codes Eperience_Code)]
Experience_Parameter 2. The integral part of the value of the fraction “Amount of seconds to amount of Experience_Codes”. The unit of measurement of Experience_Parameter 2-sdc:
Expereince_Parameter 2=[(Duration of the narrative in seconds)/(Amount of digital codes Eperience_Code)]
Experience_Parameter 3. The integral part of the value of the fraction “Amount of minutes to amount of Experience_Codes”. The unit of measurement of Experience_Parameter 3−mds:
Expereince_Parameter 3=[(Duration of the narrative in minutes)/(Amount of digital codes Eperience_Code)]
Experience_Parameter 4. The integral part of the value of the fraction “Amount of hours to amount of Experience_Codes”. The unit of measurement of Experience_Parameter 4−hds:
Expereince_Parameter 4=[(Duration of the narrative in hours)/(Amount of digital codes Eperience_Code)]

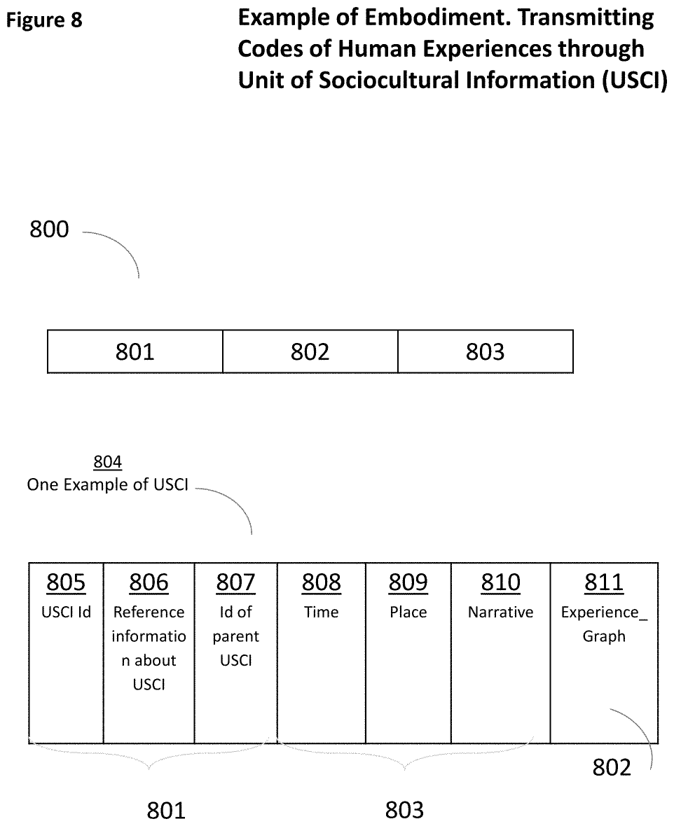

FIG. 8 depicts one embodiment of the invention in which the codes of human experiences are transmitted through a unit of sociocultural information (USCI). USCI is structured information that contains one or more semantic digital codes of human experiences in its structure. For example, parts of USCI can comprise:

801—reference Information, Id, links to related structures and blocks of information.
802—semantic digital codes and digital structures: Experience_Code, Experience Graph, Experience_Story, entry from “Library of Doings and Beings”, or entry from “Library of Contexts”.
803—other information.

USCI can be stored, transmitted, analyzed, linked, and presented to users by means of different software. For example, there can be a short narrative 804, the interpretation of a situation that one person is telling during an investigation. The interpretation can be stored and transmitted as USCI, comprising following information:

805—identification number of that short story;
806—name of the person who is telling that;
807—link to the investigation;
808—time when the interpretation was presented;
809—place where the interpretation was presented;
810—the narrative—the interpretation itself;
811—semantic digital codes of human experiences (Experience_Codes, Experience Graphs, Experience_Story) which reflect the semantic structure of the interpretation.

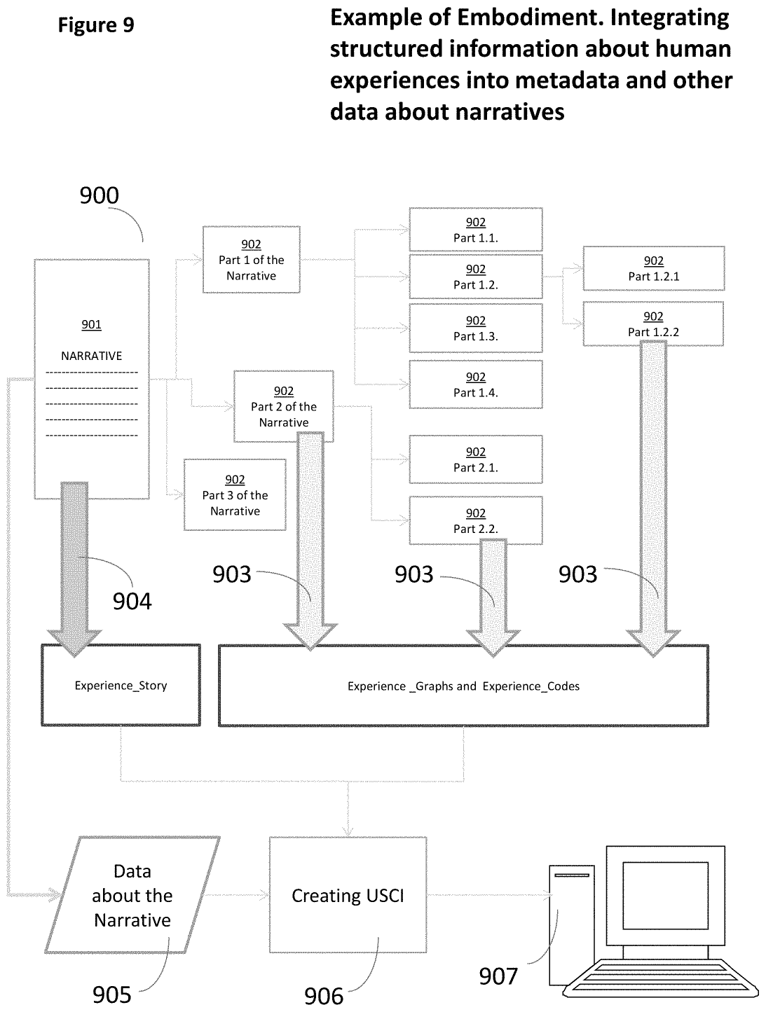

FIG. 9 depicts one embodiment of the invention that is applying the Human Experiences Ontology Data Model for attributing a narrative 900. Before attributing, the user extracts parts 902 (mentally or by means of the editing software) of the narrative 901 and determines its semantic structure. One narrative can be divided differently; it depends on the purposes of the user. There can be hierarchical structure when one part is divided to several other parts. E.g. one poem can have several parts, and those parts include little parts in rhyme. Or one video can be divided to episodes and a few scenes, and one scene can include several parts—e.g. every person or opinion in the scene.

Every part that was extracted (mentally or by using appropriate tools) is to be attributed according to the human experiences it expresses. The user chooses digital codes (identifiers) from classifications “Library of Doings and Beings” and “Library of Contexts”, maps them together, and gets Experience_Codes and Experience_Graphs that describe the human experiences of the part of the narrative 903. As the result, the whole set of the Experience_Codes and Experience_Graphs forms 904 the Experience_Story for the narrative.

The sets of semantic digital codes and structures Experience_Codes, Experience_Graphs, and Experience_Story can be integrated into metadata 905 or other data about the narrative in order to store in a database or in a computing system 907. If the codes are integrated into the metadata of the narrative then the metadata of the narrative are considered as USCI 906 (see FIG. 8).

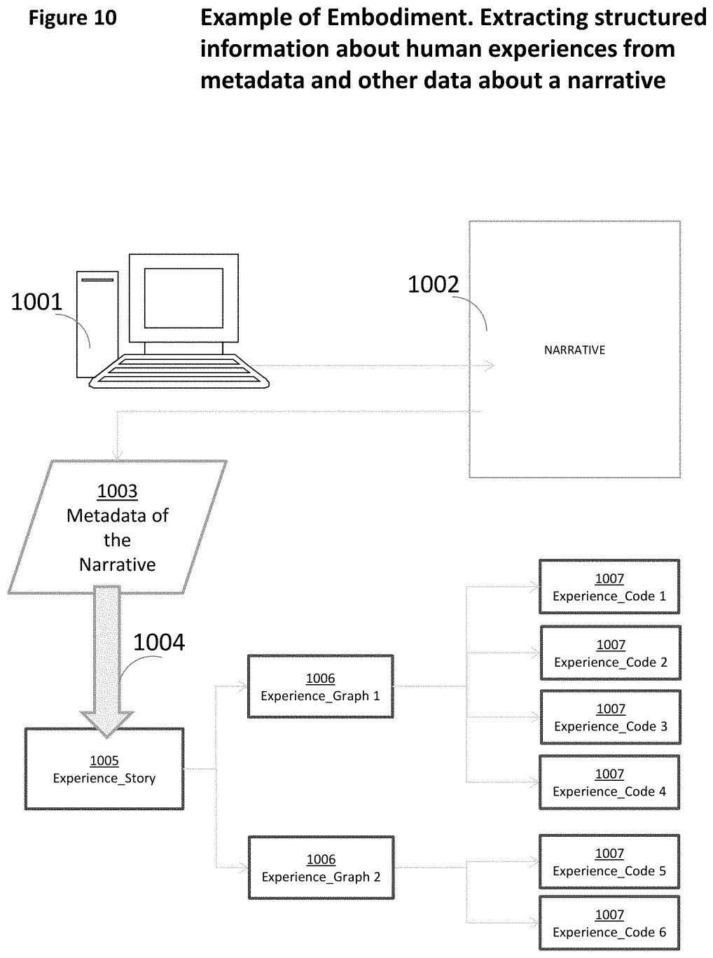

FIG. 10 depicts the example of one embodiment of the invention, a process of extracting structured information about human experiences from the metadata and other data about a narrative. In some traits, this process is reversal process to integrating Experience_Codes, Experience_Graphs, and Experience_Story into metadata and other data about narratives (see FIG. 9). After receiving the narrative itself 1002 and the information about the narrative 1003 that are being stored on computer or server 1001, users can see 1004 semantic digital codes and structures Experience_Codes, Experience_Graphs, and Experience_Story; or information system can present them to users 1004 by operating with the metadata 1003. The semantic digital codes can be unfolded as a hierarchical structure that reflects semantic structure of the narrative 1002. E.g. in the picture, the Experience_Story 1005 consists of two Experience_Graphs 1006. One of them consists of four Experience_Codes 1007. Another Experience_Graph 1006 consists of two Experience_Codes 1007. Referring to the names of the digital codes (identifiers) in classifications “Library of Doings and Beings” and “Library of Contexts” and applying rules of Human Experiences Ontology Data Model (see FIG. 1) the user may interpret the information about human experiences in the narrative. The process of the interpretation of the narrative is independent to the language of the source. The user can translate signs of the codes of human experiences to any natural language. The user can do it by their own or by using computing tools and systems.

FIG. 11 depicts one embodiment of the invention, semantic attributing of the narrative with Human Experiences Ontology Data Model. The narrative is the letter of Thomas Jefferson to his daughter Martha Jefferson. “From Thomas Jefferson to Martha Jefferson, 28 Nov. 1783”.

As the structuring of the text with Human Experiences Ontology Data Model depends on purposes of the user, there can be various results of structuring. Here, three versions (Experience_Stories) are described:

Experience_Story 1 (1101). In this case, the user is interested in attributing a document itself, e.g. as a part of an archive:

| | Human actions, states of being, | Contexts from | |
|---|---|---|---|
| | feelings, and processes from | “Library | |
| What the user describes | “Library of Doings and Beings” | of Contexts” | Experience_Codes |
| The artefact in archive | Preserving the | Letter | 800001004-10022- |
| | historical | Daughter | 10000000000134 |
| | documents | Historical | 800001004-10005- |
| | | figures | 10000000000408 |
| | | | 800001004-90056- |
| | | | 90000000000012 |

As the result, Experience_Story 1 consists of one Expereince_Graph:

800001004-10022-10000000000134
800001004-10005-10000000000408
800001004-90056-90000000000012

Experience_Story 2(1102). In this case, the user is interested in semantic attributing of the whole narrative 1100 in general and therefore in providing a short description 1102. In order to do that, the user prefers to express following semantic information: this is a letter of father to his daughter, and the father is a significant figure in history of USA.

| | Human actions, states of being, | Contexts from | |
|---|---|---|---|
| | feelings, and processes from | “Library of | |
| What the user describes | “Library of Doins and Beings” | Contexts” | Experience_Codes |
| The narrative in general | Being a father | Daughter | 800001007-10005- |
| | | Letter | 10000000000408 |
| | | Historical figures | 800001007-10022- |
| | | (from custom | 10000000000134 |
| | | classification) | 800001007-90056- |
| | | | 90000000000012 |
| | Expressing love | Daughter | 800001008-10005- |
| | | Letter | 10000000000408 |
| | | | 800001008-10022- |
| | | | 10000000000134 |
| | Organizing the | Education | 800001012-10006- |
| | process | Home | 10000000000933 |
| | | | 800001012-10005- |
| | | | 10000000000401 |

As the result, Experience_Story 2 consists of one Experience_Graph:
800001007-10005-10000000000408
800001007-10022-10000000000134
800001007-90056-90000000000012
800001008-10005-10000000000408
800001008-10022-10000000000134
800001012-10006-10000000000933
800001012-10005-10000000000401

Experience_Story 3(1103). In this case, user is interested in attributing of the narrative 1100 in details 1103 in order to prepare an example of structured semantic information for the Machine Learning processes in the project of applying Artificial Intelligence for seeking patterns in ancient narratives of that historical period.

| | Human actions, states of being, | Contexts from | |
|---|---|---|---|
| | feelings, and processes from | “Library | |
| What the user describes | “Library of Doins and Beings” | of Contexts” | Experience_Codes |
| “My dear Patsy | Expressing love | Daughter | 800001008-10005- |
| After four days journey I arrived | Being a father | | 10000000000408 |
| here without any accident and | | | 800001007-10005- |
| in as good health as when I left | | | 10000000000408 |
| Philadelphia. The conviction | | | |
| that you would be more | | | |
| improved in the situation I have | | | |
| placed you than if still with me, | | | |
| has solaced me on my parting | | | |
| with you, which my love for you | | | |
| has rendered a difficult thing. | Traveling | Letter | 800000507-10022- |
| The acquirements which I hope | | | 10000000000134 |
| you will make under the tutors I | | | |
| have provided for you will | | | |
| render you more worthy of my | | | |
| love, and if they cannot increase | | | |
| it they will prevent it's | | | |
| diminution.” | | | |
| “Consider the good lady who | Recommending | Daughter | 800001039-10005- |
| has taken you under her roof, | a person | | 10000000000408 |
| who has undertaken to see that | | | |
| you perform all your exercises, | | | |
| and to admonish you in all | | | |
| those wanderings from what is | | | |
| right or what is clever to which | | | |
| your inexperience would expose | | | |
| you, consider her I say as your | | Teacher | 800001039-10018- |
| mother, as the only person to | | | 10000000010089 |
| whom, since the loss with which | Organizing the | Education | 800001012-10006- |
| heaven has been pleased to | process | | 10000000000933 |
| afflict you, you can now look up; | | | |
| and that her displeasure or | | Home | 800001012-10005- |
| disapprobation on any occasion | | | 10000000000401 |
| will be an immense misfortune | Being a father | Education | 800001007-10006- |
| which should you be so unhappy | | | 10000000000933 |
| as to incur by any unguarded | | | |
| act, think no concession too | Organizing the | Home | 800001012-10005- |
| much to regain her good will. | process | | 10000000000401 |
| With respect to the distribution | | | |
| of your time the following is | | Education | 800001012-10006- |
| what I should approve.” | | | 10000000000933 |
| “from 8. to 10 o'clock practise | Establishing a | Home | 800001076-10005- |
| music. | schedule | | 10000000000401 |
| from 10. to 1. dance one day | | | |
| and draw another | | | |
| from 1. to 2. draw on the day | | | |
| you dance, and write a letter | | | |
| the next day. | | | |
| from 3. to 4. read French. | | | |
| from 4. to 5. exercise yourself in | | | |
| music. | | | |
| from 5. till bedtime read | | | |
| English, write &c. | | | |
| Communicate this plan to Mrs. | | | |
| Hopkinson and if she approves | | Education | 800001076-10006- |
| of it pursue it.” | | | 10000000000933 |
| “As long as Mrs. Trist remains in | Giving an advice | Daughter | 800001023-10005- |
| Philadelphia cultivate her | | | 10000000000408 |
| affections. She has been a | | | |
| valuable friend to you and her | | | |
| good sense and good heart | Supporting | Home | 800001024-10005- |
| make her valued by all who | relationships | | 10000000000401 |
| know her and by nobody on | | Friends | 800001024-10005- |
| earth more than by me.” | | | 10000000000403 |
| “I expect you will write to me by | Supporting | Daughter | 800001024-10005- |
| every post. Inform me what | relationships | | 10000000000408 |
| books you read, what tunes you | | | |
| learn, and inclose me your best | | | |
| copy of every lesson in | | | |
| drawing.” | | | |
| “Write also one letter every | Giving an advice | Daughter | 800001023-10005- |
| week either to your aunt Eppes, | | | 10000000000408 |
| your aunt Skipwith, your aunt | | | |
| Carr, or the little lady from | | | |
| whom I now inclose a letter, | | | |
| and always put the letter you so | Supporting | Relatives | 800001024-10005- |
| write under cover to me. Take | relationships | | 10000000000404 |
| care that you never spell a word | | | |
| wrong. Always before you write | | | |
| a word consider how it is spelt, | Expressing love | Letter | 800001008-10022- |
| and if you do not remember it, | | | 10000000000134 |
| turn to a dictionary. It produces | | Daughter | 800001008-10005- |
| great praise to a lady to spell | | | 10000000000408 |
| well. I have placed my | | | |
| happiness on seeing you good | | | |
| and accomplished, and no | | | |
| distress which this world can | | | |
| now bring on me could equal | | | |
| that of your disappointing my | | | |
| hopes. If you love me then, | | | |
| strive to be good under every | | | |
| situation and to all living | | | |
| creatures, and to acquire those | | | |
| accomplishments which I have | | | |
| put in your power, and which | | | |
| will go far towards ensuring you | | | |
| the warmest love of your | | | |
| affectionate father, | | | |
| Th: Jefferson | | | |
| P.S. keep my letters and read | | | |
| them at times that you may | | | |
| always have present in your | | | |
| mind those things which will | | | |
| endear you to me.” | | | |

As the result, Experience_Story 3 consists of five Experience_Graphs:

800001008-10005-10000000000408
800001007-10005-10000000000408
800000507-10022-10000000000134
800001039-10005-10000000000408
800001039-10018-10000000010089
800001012-10006-10000000000933
800001012-10005-10000000000401
800001007-10006-10000000000933
800001012-10005-10000000000401
800001012-10006-10000000000933
800001076-10005-10000000000401
800001076-10006-10000000000933
800001023-10005-10000000000408
800001024-10005-10000000000401
800001024-10005-10000000000403
800001024-10005-10000000000408
800001023-10005-10000000000408
800001024-10005-10000000000404
800001008-10022-10000000000134
800001008-10005-10000000000408

For creating Experience_Codes in the example for the embodiment in FIG. 11, the following digital codes (identifiers) from the Human Experiences Ontology Data Model were used:

| Digital code (identifier) of an | Name of human action, |
|---|---|
| attribute from “Library of | state of being, |
| Doings and Beings” | feeling, or process |
| 800001004 | Preserving the historical |
| | documents |
| 800000512 | Writing a letter |
| 800001007 | Being a father |
| 800000507 | Traveling |
| 800001008 | Expressing love |
| 800001039 | Recommending a person |
| 800001012 | Organizing the process |
| 800000014 | Being a father |
| 800001012 | Organizing the process |
| 800001076 | Establishing a schedule |
| 800001023 | Giving an advice |
| 800001024 | Supporting relationships |

| Identification number | Digital code | |
|---|---|---|
| of a group of contexts | (identifier) | |
| “Library of Contexts” | of context | Name of context |
| 10022 | 10000000000134 | Letter |
| 10005 | 10000000000408 | Daughter |
| 90056 | 90000000000012 | Historical figures |
| 10018 | 10000000010089 | Teacher |
| 10005 | 10000000000403 | Friends |
| 10006 | 10000000000933 | Education |
| 10005 | 10000000000401 | Home |
| 10005 | 10000000000404 | Relatives |

Amount of words in the narrative 1100 (the letter)—550 words.

### Experience_Parameter1 for Experience_Story 1=[550/3]=183 wdc

### Experience_Parameter1 for Experience_Story 2=[550/7]=78 wdc

### Experience_Parameter1 for Experience_Story 3=[550/19]=28 wdc

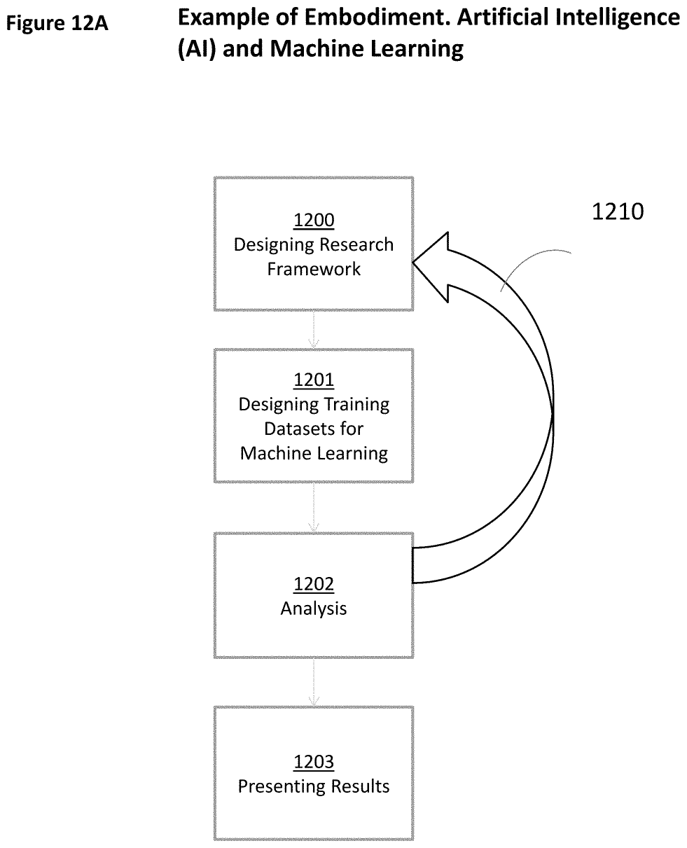

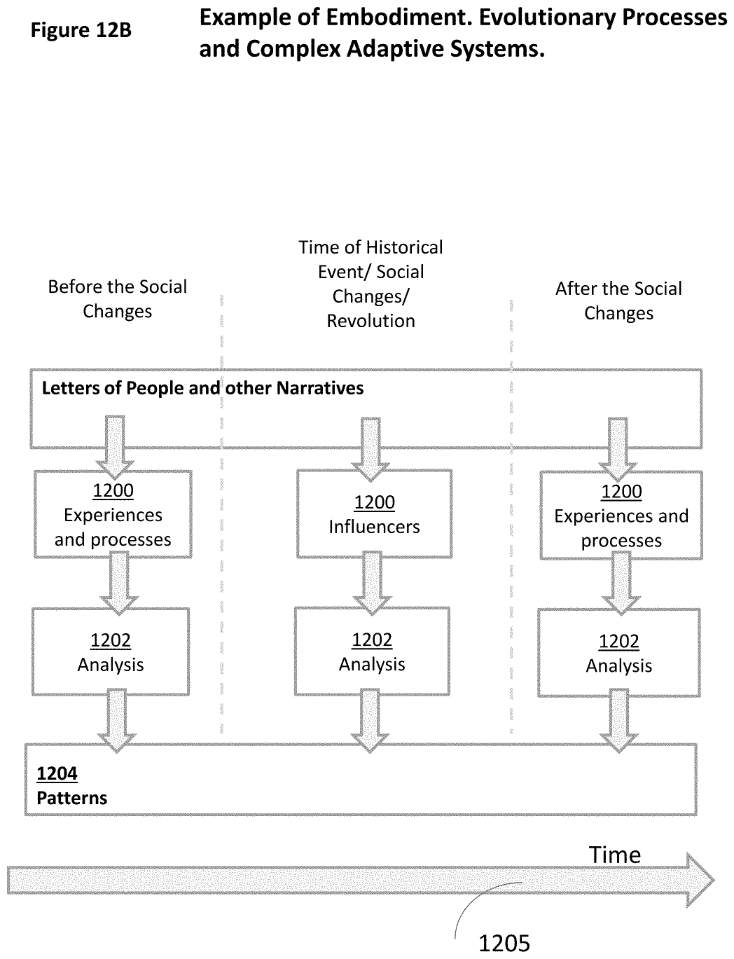

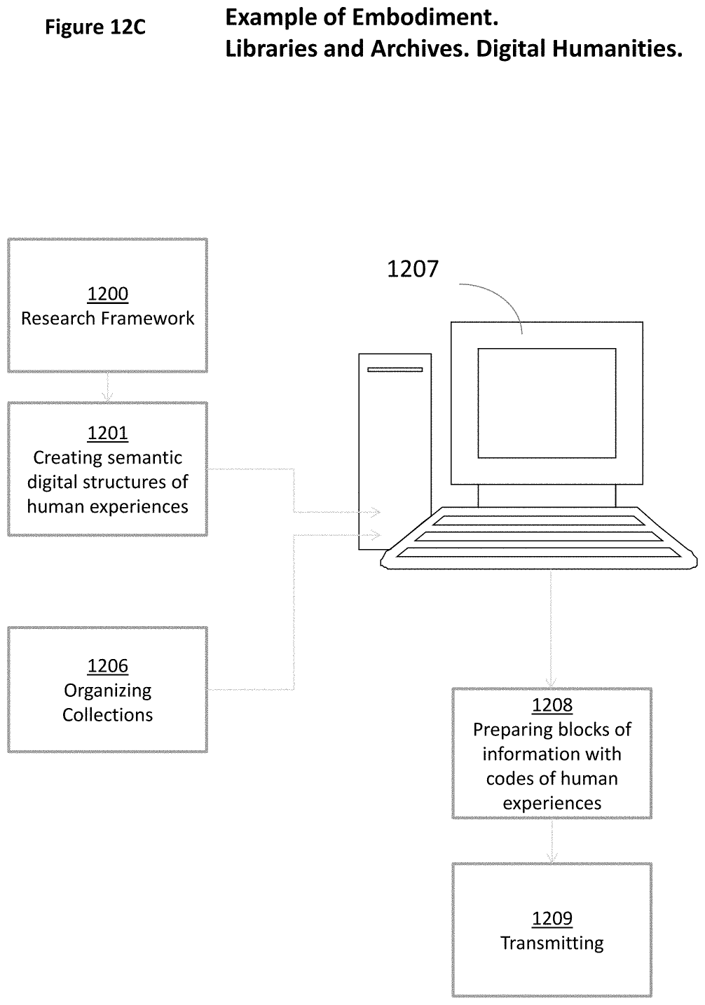

FIG. 12A-12C illustrate one example of embodiment of the invention in research where the analysis of big volumes of narratives is being provided. There are three interconnected parts of the example:

Machine Learning process—FIG. 12A
Researching social patterns—FIG. 12B
Preparing and structuring information for the research—FIG. 12C

FIG. 12A shows the example of flaw in Machine Learning processes.

The user determines purposes of the research and designs a framework 1200 with Human Experiences Ontology Data Model. There can be various frameworks 1200 the user is interested in, for example:
Political ideas expressed in the narratives;
Emotions, feelings and other subjectivity that is proposed to be estimated in the narratives;
Human values that are rooted in the personal narratives;
Language styles and its correlations to the political events of the time;
Other purposes of the research and hence frameworks.

Then the user prepares a set of narratives that can be considered as the example of the expressed political ideas/human values/language styles etc. The user designs semantic digital structures that describe human experiences of those narratives 1201 with Human Experiences Ontology Data Model (see FIG. 11). The semantic digital structures consist of Experience_Codes, Experience_Graphs, and Experience_Story. In this embodiment, they are the features for feature engineering within the Machine Learning Process. Again, the user can create several training sets of data with different sets of human experiences (features).

After that, the technologies of Artificial Intelligence can be applied for seeking the human experiences structures of the framework within big volume of narratives 1202. The results of the analysis can be presented in plenty variations 1203 in accordance to the research environment and the applied technology. The user can adjust 1210 the framework and try several versions of semantic digital structures of human experiences in order to look for the most appropriate structure of the features.

FIG. 12B depicts one embodiment of the invention for researching evolutionary processes in complex adaptive systems.

For that research, the user (researcher) may have the task of analyzing big volume of letters, diaries, and other personal narratives (see 901 in FIGS. 9 and 1100 in FIG. 11) that were written over specific time period 1205. For example, the purpose of the research can be connected to the changes in social processes before and after a political event, a huge social shift like Industrial Revolution, or a technological shift like Internet.

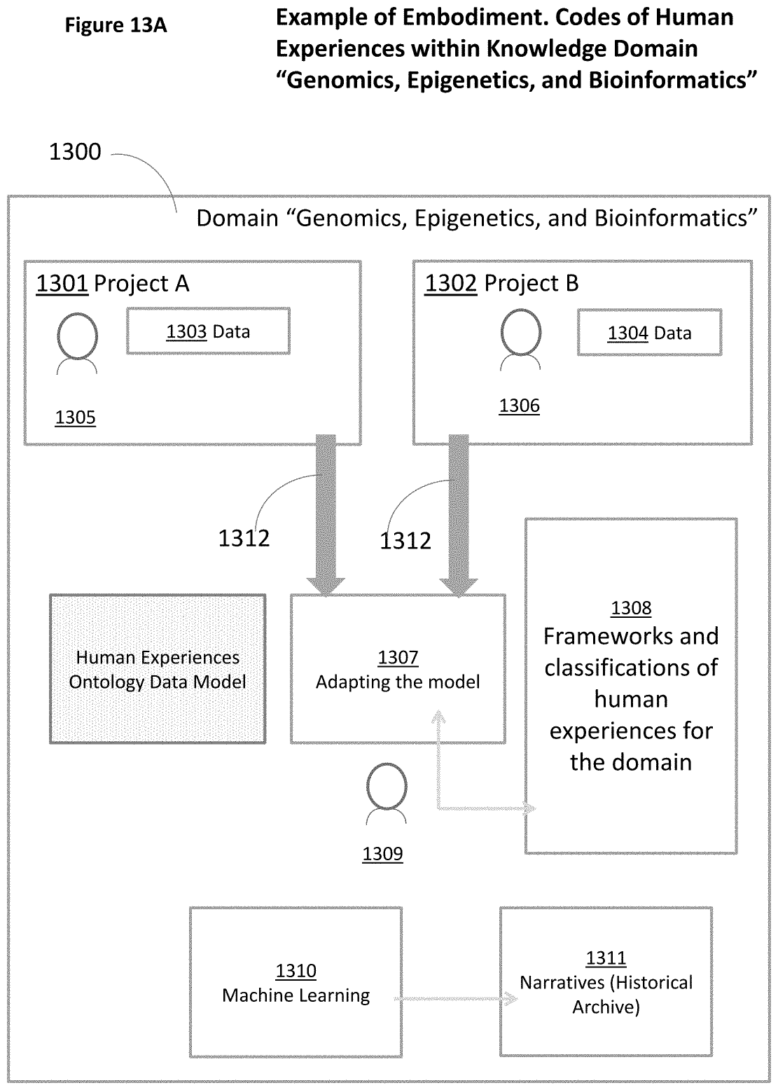

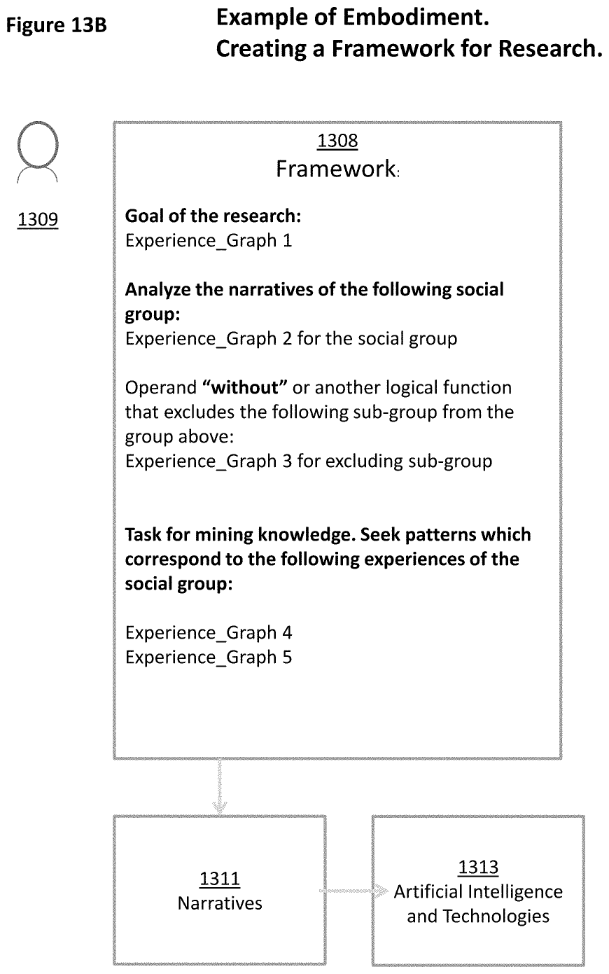

In some embodiments, the researcher can be engaged in extracting the following information from the personal narratives:
Changes in life values and senses;
Traits of the influencers who changed the situation;
Power distance within the process of changes and the role of elites;
Changes in genomes' structures while the changes occur (referring to FIG. 13);
Changes in economic narratives;
Other changes in human experiences.

Applying Machine Learning processes (see FIG. 12A) and technologies of Artificial Intelligence for analyzing big volume of narratives, the researcher creates methodology of seeking patterns in social processes 1204. Those patterns can be described by sets of Experiences_Graphs which are specific and intrinsic for different stages of the social processes—before social changes, within the process of social changes, and after social changes.

In some embodiments, patterns can be tagged with Experiences_Graphs. In other embodiments, Experiences_Graphs can reflect sets of experiences for regression analysis or classification of groups in statistical analysis. There can be plenty variants of marking structure of patterns with the codes of human experiences.

FIG. 12C depicts one embodiment of the invention that can become a part of technological processes in libraries and archives.

Libraries and archives can use the invention for their digital collections and digital projects 1207. For example, the researcher (see FIG. 12A, 12B) can send the request to a library for structuring some narratives (a part of the library's collection) within the research framework 1200 and creating training datasets for the Machine Learning process 1201. The library can do that work by preparing blocks of Experiences_Stories, Experiences Graphs, and Eperiences_Codes 1208 which are appropriate to the research 1200. Also, the library or archive can organize their collection in special blocs 1208 by providing their semantic attributes with Human Experiences Ontology Data Model. They can do that in order to present their collection for special groups of users or for internal purposes 1206. They can transmit blocks of structured narratives 1209 as blocks of USCI (see FIG. 8) to various knowledge domains.

FIG. 13A depicts one embodiment of the invention in one domain. In scientific papers, scientists who investigate the influence of social factors to genome accentuate the problem of integrating social classifications and the knowledge about social processes into genetic research. The ways in which scientists conceptualize the relationship between social identities and genetic variation create the demand for methods of structuring social information. In FIG. 13, an example of using Human Experiences Ontology Data Model for addressing the problem is presented.

Project A 1301 is a research project that collects data on allelic distributions within human populations. Researchers who work within the project 1305 may describe the populations on which they focused 1303 using common classifications and characteristics of social identities. At the same time, they can describe social groups as groups of people who have the same set of human experiences, same rites of passage, and same historical heritage in narratives. Referring to FIG. 1 and FIG. 9, those human experiences, which are the intrinsic characteristics of the social group, can be described as semantic digital structures with Human Experiences Ontology Data Model.

Project B 1302 investigates epigenetic processes, how social experiences trigger changes in the various molecules that interact with DNA. Researchers who work within the project 1306 may describe the social factors that influence the genome 1304 as the set of experiences which some groups of people experience intensively. In this case, essential narratives are stories of people, their documents and memoirs. Those specific human experiences can be described as semantic digital structures (see FIG. 1 and FIG. 9) with Human Experiences Ontology Data Model.

In Project B, that semantic digital structure might be associated with specific genome sequences.

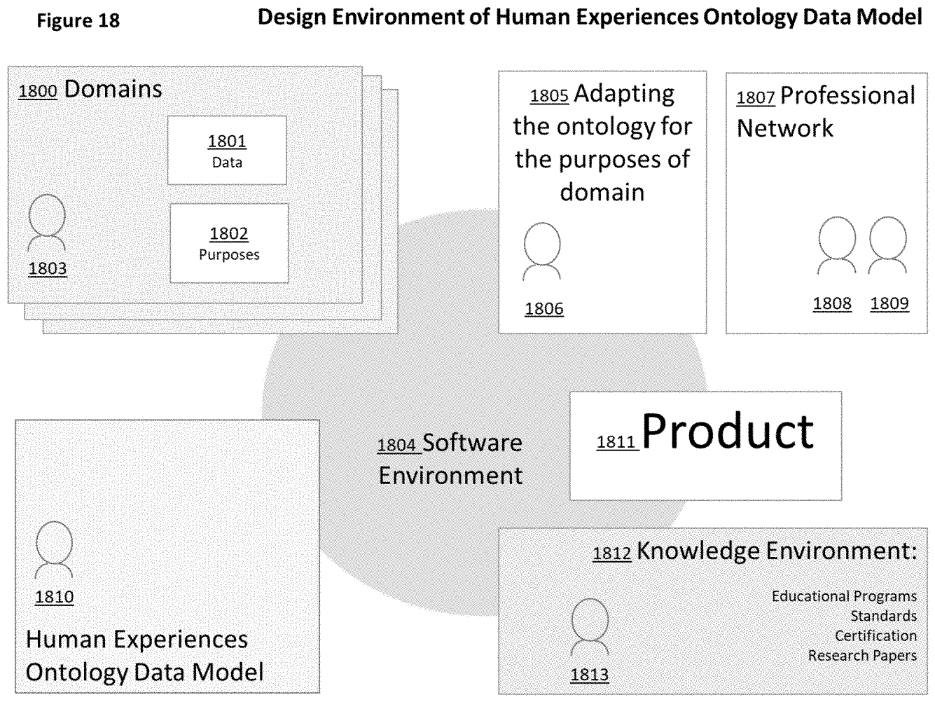

Specialists of the Projects A and B can be interested in specific fields of Human Experiences Ontology Data Model that do not exist at the moment 1312. The specialist of the domain “Genomics, Epigenetics and Bioinformatics” who has rights for adapting Human Experiences Ontology Data Model for the purposes of the domain (see “special roles” in FIG. 18) 1309 adapts classifications “Library of Doings and Beings” and “Library of Contexts” 1307, designs frameworks of human experiences 1308, and creates data marts or other presentation of semantic digital structures of human experiences. Those frameworks can be shared between projects within the domain. Additionally, using data of Project B, the specialist 1309 can create a specific classification which might be used by Project A and Project B as for own purposes, as for exchanging research data. Also, there can emerge another project which will use frameworks 1308 for Machine Learning processes 1310 within the domain. For example, there can appear the need of investigating historical archive of narratives 1311 of other populations (social groups) with scenarios of human experiences that were disclosed within projects A and B.

FIG. 13B depicts one embodiment of the invention for creating a research framework.

Referring to FIG. 13A, the researcher 1309 prepares a framework with Human Experiences Ontology Model for the researching one social group of women. The researcher is interested in the influence of stressful social factors on the genome structures. For the preparing the framework, the researcher creates several Expereince_Graphs.

At the beginning, the researcher creates Experience_Graph which describes the goal of the research:

| Human actions, states of being, | Contexts from | |
|---|---|---|
| feelings, and processes from | “Library | |
| “Library of Doins and Beings” | of Contexts” | Experience_Codes |
| Researching the | Genome | 300000555-70121- |
| frequency | identifier | 00344000238767 |
| (specific | #343 | |
| genome | | |
| structure) | | |
| Having changes | From peace | 800002605-10008- |
| in genome | to war Poor | 10000000200007 |
| | | 800002605-10010- |
| | | 10000000000203 |

### Experience_Graph 1:

300000555-70121-00344000238767
800002605-10008-10000000200007
800002605-10010-10000000000203

Step 2. Then the researcher designs Experience_Graphs which can describe the social group 1. In order to describe the social identities of women, the researcher use some traits like specific rite of passages, eating traditions, geographical areas and others.

| Human actions, states of being, | Contexts from | |
|---|---|---|
| feelings, and processes from | “Library | |
| “Library of Doins and Beings” | of Contexts” | Experience_Codes |
| Being a woman | Adult | 800002005-10009- |
| | | 10000000000539 |
| Using animals as | Mussels | 800002134-91340- |
| | | 00000000342402 |
| food | Tuna | 800002134-91340- |
| | | 00000000234005 |
| Using animals | Horse | 800002135-91340- |
| for transporting | | 00000000100058 |
| Attending to | Rite of passage A | 800002011-10201- |
| event | | 10000000200345 |
| Settling in a | Geographical area | 800000170-60034- |
| place | | 00000002GTG067 |

Experience_Graph 2 for the social group:
800002005-10009-10000000000539
800002134-91340-00000000342402
800002134-91340-00000000234005
800002135-91340-00000000100058
800002011-10201-10000000200345

### 800000170-60034-00000002GTG067

Step 3. Then the researcher designs Experience_Graph which describes the social sub-group that should be excluded from the research (from the social group above).

| Human actions, states of being, | Contexts from | |
|---|---|---|
| feelings, and processes from | “Library of | |
| “Library of Doins and Beings” | Contexts” | Experience_Codes |
| Being a woman | Rich | 800002005-10010- |
| | | 10000000000202 |
| Being a woman | Aristocracy | 800002005-10010- |
| | | 10000000000204 |

Experience_Graph 3 for excluding sub-group:
800002005-10010-10000000000202
800002005-10010-10000000000204
Step 4. Then the researcher designs Experience_Graphs which describes the specific experience of the social group that are connected to the changes in genome:

| Human actions, states of being, | Contexts from | |
|---|---|---|
| feelings, and processes from | “Library | |
| “Library of Doins and Beings” | of Contexts” | Experience_Codes |
| Leaving home | From peace | 800022129-10008- |
| | to war | 10000000200007 |
| Being a parent | Poor | 800022330-10010- |
| | | 10000000000203 |
| Taking care | Children | 800022146-10005- |
| | Disease YYY | 10000000000406 |
| | | 800022146-30007- |
| | | 0000000020A.56 |
| Responding to | Children | 800001161-10005- |
| crises | Disease YYY | 10000000000406 |
| | From peace | 800001161-30007- |
| | to war | 0000000020A.56 |

| Human actions, states of being, | Contexts from | |
|---|---|---|
| feelings, and processes from | “Library | |
| “Library of Doins and Beings” | of Contexts” | Experience_Codes |
| Having changes | Genome | 800002605-70121- |
| in genome | identifier | 00344000238767 |
| | 343 | |

### Experience_Graph 4:

800022129-10008-10000000200007
800022330-10010-10000000000203
800022146-10005-10000000000406

### 800022146-30007-0000000020A.56

800001161-10005-10000000000406

### 800001161-30007-0000000020A.56

### Experience_Graph 5:

800002605-70121-00344000238767

For creating semantic digital codes and semantic digital structures, the following parts of Human Experience Ontology Data Model (examples for demonstrating the principle) were used:

| Digital codes (identifiers) | |
|---|---|
| from the classification | Names from “Library of |
| “Library of Doings and Beings” | Doings and Beings” |
| 800002005 | Being a woman |
| 800002134 | Using animals as food |
| 800002135 | Using animals for transporting |
| 800002011 | Attending to event |
| 800000170 | Settling in a place |
| 800022129 | Leaving a home |
| 800022330 | Being a parent |
| 800022146 | Taking care |
| 800001161 | Responding to crises |
| 300000555 | Researching the frequency |
| | (specific genome structure) |

Contexts from standard part of the classification “Library of Contexts”:

| Identification | Digital code | |
|---|---|---|
| number of group of | (identifier) | |
| contexts | of context | Name of context |
| 10009 | 10000000000539 | Adult |
| 10201 | 10000000200345 | Rite of passage A |
| 10008 | 10000000200007 | From peace to war |
| 10005 | 10000000000406 | Children |
| 10010 | 10000000000203 | Poor |
| 10010 | 10000000000202 | Rich |
| 10010 | 10000000000204 | Aristocracy |

Contexts from the external classifications:

| Identification | | |
|---|---|---|
| number of group of | | |
| contexts (Identification | | |
| number of the external | | |
| classification within | Digital code | |
| Human Experiences | (identifier) | |
| Ontology Data Model) | of context | Name of context |
| 60034 | 00000002GTG067 | Geographical area A |
| 70121 | 00344000238767 | Genome identifier 343 |
| 30007 | 0000000020A.56 | Disease #53 |
| 91340 | 00000000342402 | Mussels |
| 91340 | 00000000234005 | Tuna |
| 91340 | 00000000100058 | Horse |

Now, the framework of the research 1308 can be described as semantic digital structure:

Goal of the research:

### Experience_Graph 1

300000555-70121-00344000238767
800002605-10008-10000000200007
800002605-10010-10000000000203

Analyze the narratives 1311 of the following social group:

Experience_Graph 2 for the social group
800002005-10009-10000000000539
800002134-91340-00000000342402
800002134-91340-00000000234005
800002135-91340-00000000100058
800002011-10201-10000000200345

### 800000170-60034-00000002GTG067

Logical operand “without” or another logical function that excludes the following sub-group from the group above:

Experience_Graph 3 for excluding sub-group
800002005-10010-10000000000202
800002005-10010-10000000000204

Mining knowledge with Artificial Intelligence processes 1313.

The task for mining knowledge:

Seek patterns which correspond to the following experiences of the social group.

### Experience_Graph 4

800022129-10008-10000000200007
800022330-10010-10000000000203
800022146-10005-10000000000406

### 800022146-30007-0000000020A.56

800001161-10005-10000000000406

### 800001161-30007-0000000020A.56

### Experience_Graph 5

800002605-70121-00344000238767

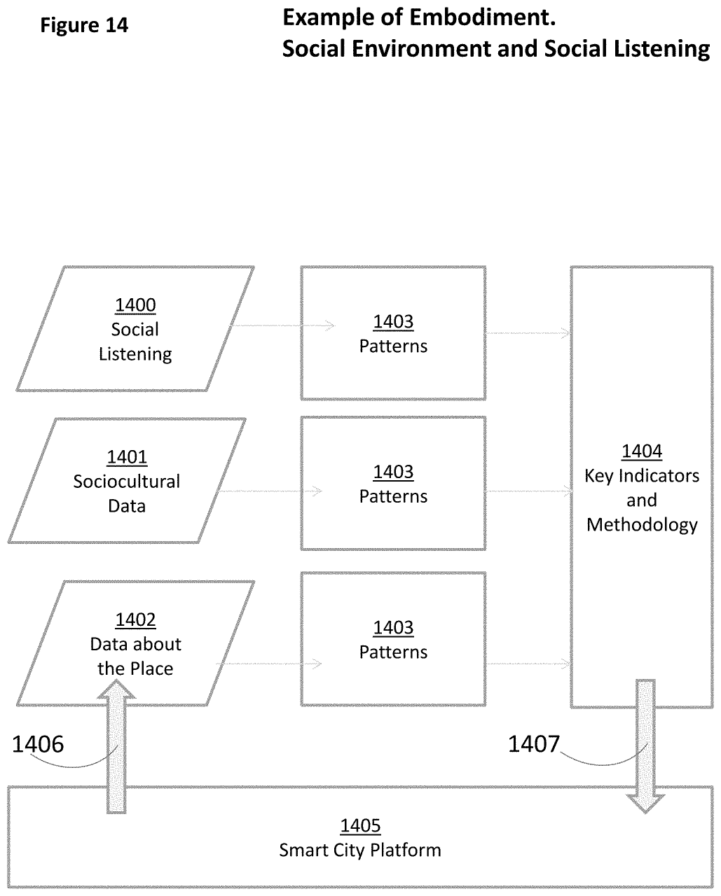

FIG. 14 depicts one embodiment of the invention in an analytical system that uses various data for analyzing social environment.

The system can use data of social nets and “social listening” platforms that is gathered for specific region and period 1400. The system can use sociocultural data about the place 1401, like historical events, mentality, traditions, values etc. The system can use data from devices that provide various characteristics of the place 1402, like data about weather, traffic, addresses etc. All the data 1440, 1401, 1402 integrated together are used by a researcher for seeking patterns which describe the social environment 1403. The user (researcher) describes the patterns by semantic digital structures of human experiences Experience_Graphs. Analyzing how human experiences correlate to the data, analyzing patterns (groups of Experience_Graphs) the researcher creates a system of key indicators within the methodology he works with 1404. The key indicators (like diversity of human experiences) can be used as for the purposes of the research as for transmitting data to a computer platform like the special computer program for Smart City technologies 1405. In this embodiment, there can be reciprocal process of exchanging the information with the Smart City platform—the key indicators about social environment are transmitted to the platform 1407, and other data from the platform are transmitted to the system 1406 for creating patterns 1403, comprising sets of Experience_Graphs.

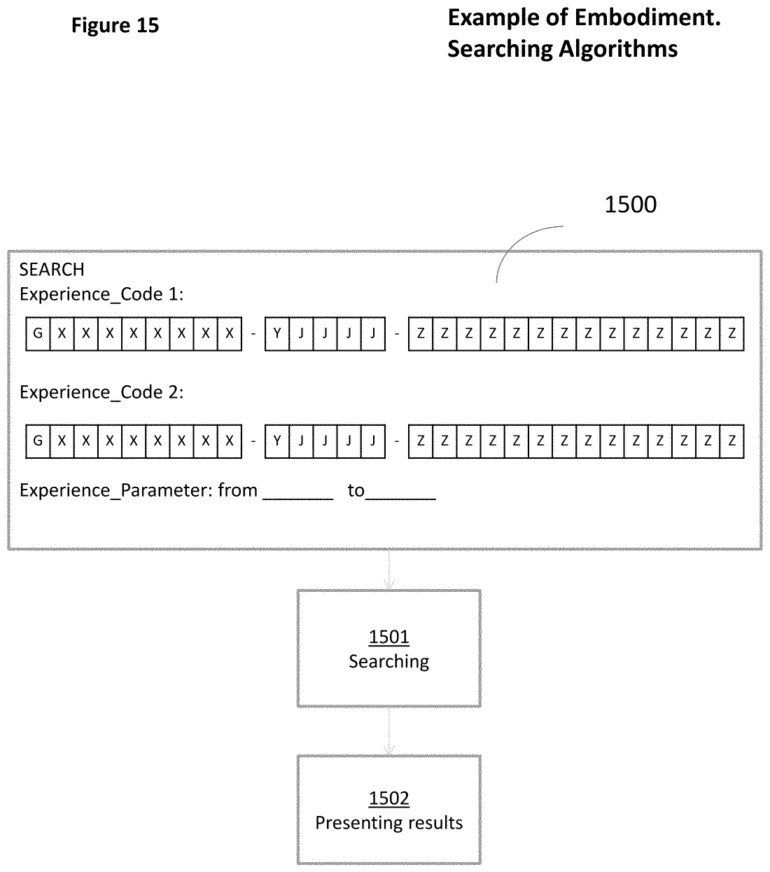

FIG. 15 depicts one embodiment of the invention in searching machines. In this example of embodiment, the user is interested in materials prepared by libraries and archives (see FIG. 12C) which contain a specific structure of human experiences. The user of searching program is seeking specific Experience_Codes in the Experience_Graphs of the narratives. The user inputs the Experience_Codes, or parts of Experience_Codes, into the browser or another interface of computing program 1500. By means of the interface of the computing program, the user can limit the results of searching with Experience_Parameter Also, there can be other parameters of narratives for searching. Searching algorithm (computing program) operates with materials and narratives containing semantic digital codes and semantic digital structures of human experiences in their metadata 1501 and chooses the materials that are appropriate to the request of the user. The result of the searching—links to the appropriate materials or the narratives themselves—is to be presented to user 1502 in formats that the computing program (the interface) provides.

For example, the custom classification of animals was used for modelling the framework for research (see 13B). The author of the classification might be interested in which projects his or her classification is being used. For investigating that, he or she inputs the 5-character identification number of the classification 91340 (YJJJJ positions in Experience_Code) and leaves other parts blank. Searching algorithms present links to materials which have the metadata structured in accordance with Human Experiences Ontology Data Model, and one or more Experience_Codes in metadata has the code “91340” on the place of identification number of group of contexts.

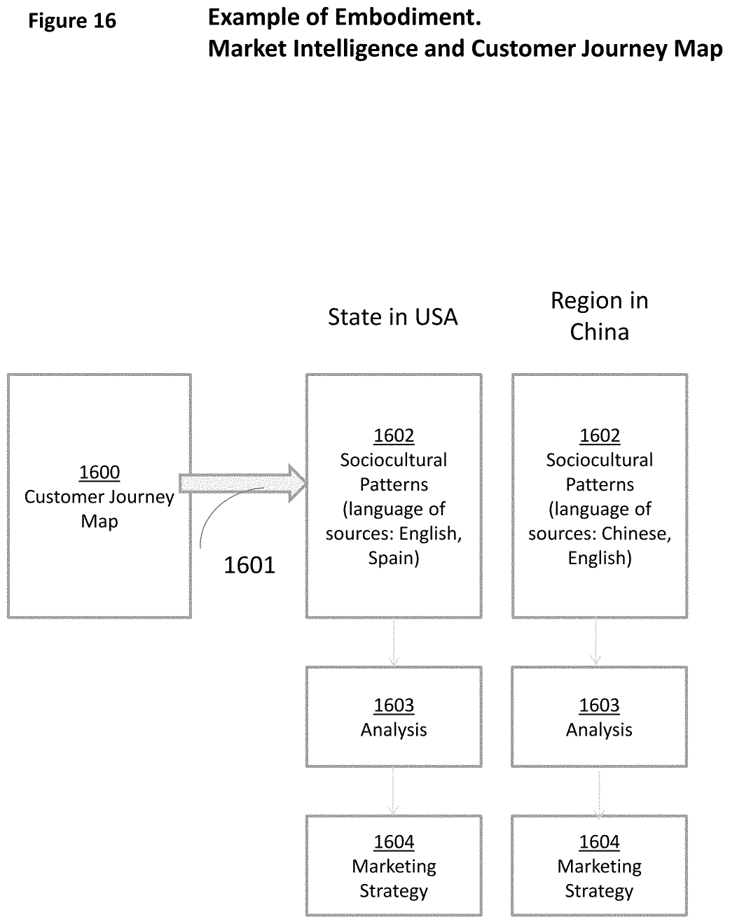

FIG. 16 depicts one embodiment of the invention in Market Intelligence area. For marketing purposes, a specialist of one company creates a Customer Journey Map 1600. The intention of the specialist is to investigate customer experience in the process of dealing with their company. During the investigating, the specialist pays attention that some cultural values of clients and their mindset traits influence their perception of the cooperation with the company. In order to understand them deeper, the specialist researches sociocultural patterns which are common cultural heritage for the clients 1601 and discover that those patterns are different in different countries. In order to understand deeper how the clients perceive some experiences that the company provide, the specialist create a framework of semantic digital codes of those human experiences with Human Experiences Ontology Data Model. With computer implemented analytical instruments, the specialist investigates the same framework of human experiences within different languages and cultural heritage 1602 and analyzes 1603 the values and heritage which make sense in the communicating. The results of the analysis can trigger some changes in marketing strategy of the company 1604.

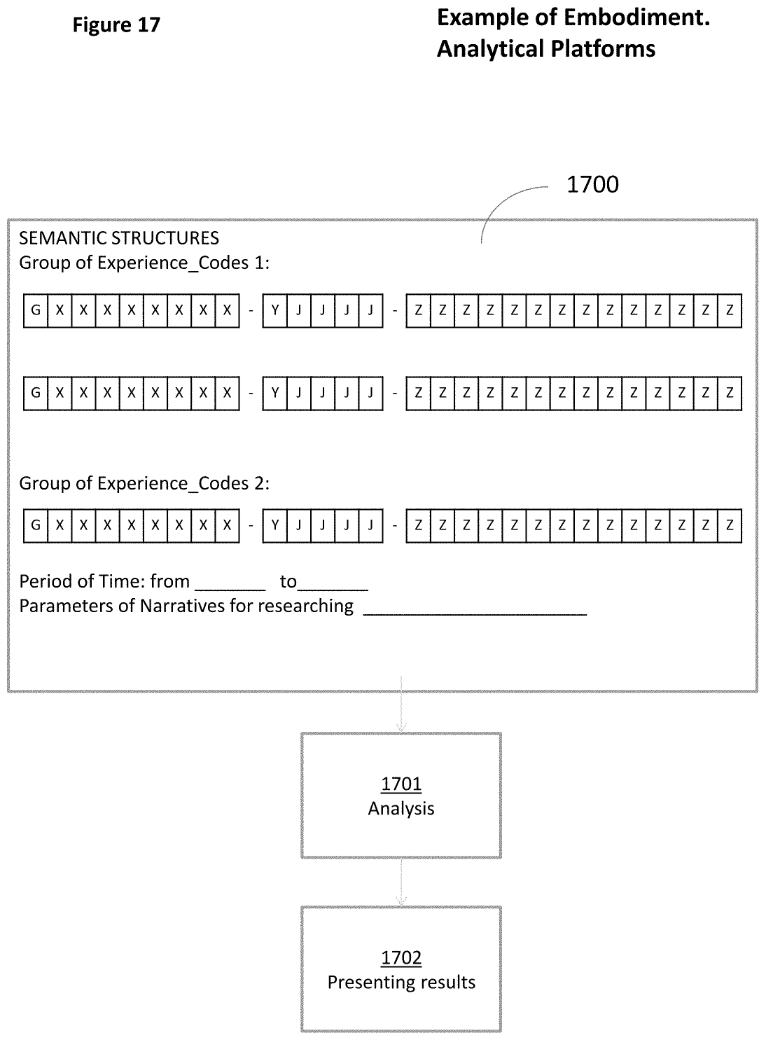

FIG. 17 depicts one embodiment of the invention, analytical system that uses Human Experiences Ontology Data Model. The system analyzes narratives and provides linguistic and structural analysis of the narratives. Using the interface of the system 1700, the researcher request analyzing of the chosen sets of narratives. In order to do that the researcher inputs information about groups of Experience_Codes and Experience_Graphs. For example, the researcher can be interested in the influence of specific experiences in childhood to one disorder in adulthood. For that, the researcher analyses the correlation of specific human experiences (See FIG. 13B). When the Machine Learning processes and statistical analysis for the analytical system are completed the researcher inputs different Experience_Codes in order to analyze their influence within the mathematical model.

In this example of embodiment, the analytical system provides seeking for correlation between the groups of experiences 1701 in the big volume of narratives, provides other analysis, and presents results of the analysis 1702 in its own format.

FIG. 18 illustrates Design Environment of the Human Experiences Ontology Data Model.

Design Environment of the Human Experiences Ontology Data Model (design environment) is the complex network of domains 1800, knowledge databases, professional associations 1807 and methodological approaches. The purpose of creating, organizing, and supporting the design environment of the Human Experiences Ontology Data Model is to ensure correct and effective application of Human Experiences Ontology Data Model and qualitative production of Product.
Domain—professional network and software within one professional or research area where the Human Experiences Ontology Model is applied, including processes and software where Experience_Code, Experience_Graph, Experience_Story, or Expereince_Parameter are being used, created, edited, stored, or transmitted. One domain can have special classifications and libraries which are adapted to the Human Experiences Ontology Model. Those classifications, libraries, frameworks, and other semantic digital structures of human experiences can be shared between different projects and entities of the domain. Here are several examples of professional fields that will be considered as domains within Design Environment of Human Experiences Ontology Model (the list of fields is not complete, plenty other areas can be added to it):
   Metadata standards
   Medical research
   Anthropology
   Sociocultural environment analysis
   Law
   Genomics
   Bioethics
   Smart City
   Education
   Artificial Intelligence
   Visualization
   Libraries
   Museums
   Virtual and augmented reality
   Knowledge Management

Product 1811 is an information service, information structure, analytical conclusion, or other information product that use semantic digital codes and semantic digital structures Experience_Code, Experience_Graph, Experience_Story, USCI, or Expereince_Parameter within the process of production or in the process of presenting the result to customers.

Parts and participants of the design environment are connected through the complex information systems—Software environment 1804 which includes different types of computer software products. Computer software products are tools for creating, using, editing, storing or transmitting Experience_Codes, Experience_Graphs, Experience_Stories, USCI, or Expereince_Parameters. Computer software products may be written in any of various programming languages. The computer software product may be an independent application, distributed object, component software, or an operating system. Computers may be connected to a network and may interface to other computers using networks.

Within Design Environment of the Human Experiences Ontology Data Model special roles of specialists can be established within the System of Rules and Formats (see FIG. 1). There might be special qualification requirements and certification for the special roles, for example:

Specialist 1810 who manages the classification of human actions, states of being, feelings, and processes “Library of Doings and Beings” or classification of contexts “Library of Contexts”;
Specialist 1803 who is responsible for integrating the Human Experiences Ontology Data Model into their domain and supporting its functioning;
Specialist 1806 who is responsible for adapting the Human Experiences Ontology Data Model 1805 for the purposes of research 1802 and creating frameworks with the data of the domain 1801;
Specialist 1813 who is responsible for creating educational resources and programs for Human Experiences Ontology Data Model;
Other specialists 1808 within the professional networks who support Knowledge environment 1812.

Also there are various users who are not required to follow special educational programs 1809.

Knowledge environment 1812 includes:

Standards and formats for different parts of the Human Experiences Ontology Data Model;
Educational programs and tutorial documents, libraries of exemplary frameworks;
Requirements to systems, organizations, and technologies that are involved to the processes of creating, storing, and transmitting semantic digital codes and semantic digital structures of human experiences.

What is claimed is:

1. A method, comprising:
a method and a system for designing semantic structures of information;
a classification of human actions, states of being, feelings, or processes;
a classification of contexts;
a method of mapping identifiers of said human actions, states of being, feelings, or processes, to identifiers of said contexts in order to integrate characters of the identifiers into a semantic structure or a code;
codes of human experiences that can be the same for the same experiences at least in two different natural languages.

2. The method as claimed in claim 1, comprising means for connecting characters of one identifier of human action, state of being, feeling, or process to characters of said identifier of context in order to create a code of human experience as the combination of the identifiers. Said code of human experience can be represented on paper without any device or performed with multitude computer programs, or data visualization platforms, or devices.

3. The method as claimed in claim 1, comprising a Human Experiences Ontology Data Model that consists of said identifiers, databases and method for designing said codes of human experiences—semantic digital codes of human experiences and semantic digital structures of human experiences.

4. The Human Experiences Ontology Data Model as claimed in claim 3, comprising following semantic digital codes and semantic digital structures of human experiences:
Experience_Code (in the plural—Experience_Codes)
Experience_Graph (in the plural—Experience_Graphs)
Experience_Story (in the plural—Experience_Stories)

5. The method as claimed in claim 1, comprising a computer implemented metasystem of attributing semantic structures of content, data, or other information with codes of human experiences, wherein:
the semantic digital code of human experience which consists of 3 parts:
the 9-character digital code (identifier) of a human action (or state of being, or feeling, or process);
the 5-character identification number of one group of contexts;
the 14-character digital code (identifier) of one context;
format of digital codes (identifiers) of human actions, states of being, feelings, and processes;
format of digital codes (identifiers) of contexts;
format of identification numbers of groups of contexts.

6. The computer implemented system as claimed in claim 5, comprising:
process of creating, storing, presenting, searching, or transmitting said semantic digital identifiers and said codes of human experiences
process of arranging said semantic digital identifiers and codes of human experiences in various ways. Approximately, those ways of arranging semantic structures can be yet are not limited to:
storing the codes of human experiences in metadata;
retrieving the codes of human experiences from metadata;
arranging the codes of human experiences as a dataset;
arranging the codes of human experiences as features for machine learning and deep learning processes;
transmitting the codes of human experiences in database;
printing the codes of human experiences as an annotation for a narrative;
attaching the codes of human experiences as attributes of a digital information;
attaching the codes of human experiences as an attribute of a genome allele or a gene sequence;
integrating the codes of human experiences into searching algorithms;
arranging the codes of human experiences within a logic table or schema;
arranging the codes of human experiences on a map;
translating the codes of human experiences into a story;
creating video-narrative based on the codes of human experiences.

7. The Human Experiences Ontology Data Model as claimed in claim 3, comprising identifiers of contexts which are addressed to entries of external registries, taxonomies or classifications designed beyond the Human Experiences Ontology Data Model. The identifiers of contexts based on external registries can be created from the same characters like the correlated entries in external registries, taxonomies or classifications.

8. The method as claimed in claim 1, comprising database where said identifiers and identification numbers of groups of contexts are primary keys in tables of a database.

9. A system for creating, storing, presenting, searching, or transmitting semantic digital codes of human experiences, comprising:
a registry of identifiers of actions, states of being, feelings, or processes
a registry of identifiers of contexts
means for mapping entries from registry of activities or states of being to entries from registry of contexts for creating semantic digital code of human experience

10. The method as claimed in claim 9, comprising codes of human experiences for describing structures of patterns in various analytical applications.

11. The method as claimed in claim 9, comprising:
databases where the identifiers and the whole registries are stored;
means for mapping fields from the table in which the registry of identifiers of activities and states of being is stored to fields from the table in which the registry of contexts is stored.

12. The method as claimed in claim 9, comprising identifiers of external classifications, ontologies or taxonomies as a part of the registry of identifiers of contexts, wherein:
said identifiers of external classifications are presented as identification numbers of groups of contexts within the method.

13. The method of claim 9, comprising means for designing tags and markups for different types of information by mapping identifiers of activities, states of being, feelings to contexts.

14. A metalanguage and a design environment, comprising
a system of signs for transforming semantic information into a set of codes of human experiences, and in opposite way—getting stories, narratives, data, semantic content, entries and other information from a set of codes of human experiences;
identifiers of contexts that are the same for the same contexts at least in two different natural language;
codes of human experiences that are appropriate substantially at least in two different knowledge domains;
a method and means for designing the codes of human experiences.

15. The metalanguage of claim 14, comprising method of creating tags and markups for different types of information (narratives, data, patterns, etc.) with said codes of human experiences.

16. The metalanguage of claim 14, comprising means for codifying information with the following semantic digital structures:
Experience_Code (in the plural—Experience_Codes)
Experience_Graph (in the plural—Experience_Graphs)
Experience_Story (in the plural—Experience_Stories)

17. The metalanguage of claim 14, comprising means for transmitting semantic structures of information, data, or narrative from one person to another, comprising:
a method of integrating the codes of human experiences into metadata;
a database or other logic table where said identifies and said codes of human experiences can be stored, and from which said codes of human experiences can be retrieved;
an ontology, taxonomy, or classification that includes said codes of human experiences in its structure or in fields.
